(19) United States
(12) Patent Application Publication
(10) Pub. No.: US 2024/0373344 A1
(43) Pub. Date: Nov. 7, 2024

(54) POWER SAVE FOR ACCESS POINTS IN WIRELESS NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Plano, TX (US); Yue Qi, Plano, TX (US); Elliot Jen, Taipei City (TW)

(21) Appl. No.: 18/637,278

(22) Filed: Apr. 16, 2024

Related U.S. Application Data
(60) Provisional application No. 63/464,357, filed on May 5, 2023.
(60) Provisional application No. 63/465,968, filed on May 12, 2023.
(60) Provisional application No. 63/470,294, filed on Jun. 1, 2023.

(51) Int. Cl. H04W 52/02; H04W 76/16

(52) U.S. Cl. CPC H04W 52/0206; H04W 76/16

(57) ABSTRACT

A wireless communication network includes an access point (AP) device, the AP device including at least one AP affiliated with the AP device, a processor coupled to the at least one AP, the processor configured to: establish one or more links between the AP device and the non-AP device, wherein at least one link is a power save (PS) link that switches between a light PS mode and a non-PS mode, generate a frame indicating that at least one link, and transmit the frame to the non-AP device.

### CROSS-REFERENCE TO RELATED APPLICATIONS

This application claims the benefit of priority from U.S. Provisional Application No. 63/436,357, entitled “Cross Link Wake Up Request for Power Save in Next Generation Wi-Fi Networks,” filed May 5, 2023, U.S. Provisional Application No. 63/465,968, entitled “Medium Synchronization Recovery Procedures for Next Generation Wi-Fi Networks” filed May 12, 2023, and U.S. Provisional Application No. 63/470,294, entitled “Link Management for Power Save Procedure in Wi-Fi Networks” filed Jun. 1, 2023, all of which are incorporated herein by reference in their entirety.

### TECHNICAL FIELD

This disclosure relates generally to a wireless communication system, and more particularly to, for example, but not limited to, power save for access points (APs) in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provide an access point (AP) device associated with a non-AP device in a wireless network. The AP device comprises at least one AP affiliated with the AP device and a processor coupled to the at least one AP. The processor is configured to: establish one or more links between the AP device and the non-AP device, wherein at least one link is a power save (PS) link that switches between a light PS mode and a non-PS mode. The processor is configured to generate a frame indicating the at least one link. The processor is configured to transmit the frame to the non-AP device.

In some embodiments, the AP device comprises at least two APs affiliated with the AP device, wherein the processor is configured to establish at least two links between the AP device and the non-AP device, and wherein the frame indicates that each link operates as a power save (PS) link or a non-PS link.

In some embodiments, a first AP that has established a first link operating as the non-PS link is in awake state, and a second AP that has established a second link operating as the PS link alternates between the light PS mode and the non-PS mode, the first link being established between the first AP and a first station (STA) affiliated with the non-AP device, the second link being established between the second AP and a second STA affiliated with the non-AP device.

In some embodiments, the processor is further configured to cause the first AP to transmit information for the second STA to the first STA via the first link when the second AP is in doze state in the second link.

In some embodiments, the processor is further configured to cause the first AP to communicate latency sensitive traffic for the second STA with the first STA via the first link when the second AP is in doze state in the second link.

In some embodiments, the processor is further configured to: receive a request frame, from the non-AP device, requesting reconfiguration for non-PS link and PS link on at least one link between the AP device and the non-AP device, and in response to the request frame, transmit a response frame, to the non-AP device, indicating reconfiguration for non-PS link and PS link on the at least one link between the AP device and the non-AP device.

In some embodiments, a primary channel of a link operating as non-PS link is the same as a primary channel of a link operating as non-PS link in a neighboring AP device.

In some embodiments, a primary channel of a link operating as non-PS link is a part of the operational bandwidth of a link operating as non-PS link in a neighboring AP device.

In some embodiments, latency sensitive traffic or emergency preparedness communications service (EPCS) traffic is communicated on a link operating as non-PS link.

In some embodiments, latency sensitive traffic is communicated on a link operating as a PS link when latency requirements of the latency sensitive traffic are met on the PS link.

In some embodiments, multi-AP coordination traffic is communicated on a link operating as non-PS link.

One aspect of the present disclosure provides a non-access point (non-AP) device associated with an AP device in a wireless network. The non-AP device comprises at least one station (STA) affiliated with the non-AP device and a processor coupled to the at least one STA. The processor is configured to establish one or more links between the non-AP device and the AP device, wherein at least one link is a power save (PS) link that switches between a light PS mode and a non-PS mode. The processor is configured to receive a frame indicating the at least one link. The processor is configured to cause the at least one STA to communicate with the AP via the at least one link.

In some embodiments, the non-AP device comprises at least two STAs affiliated with the non-AP device, wherein the processor is configured to establish a first link between a first STA affiliated with the non-AP device and a first AP affiliated with the AP device, and a second link between a second STA affiliated with the non-AP device and a second AP affiliated with the AP device, wherein the frame indicates that the first link operates as non-power save (PS) link and the second link operates as PS link, wherein the processor is further configured to: cause the first STA to communicate with the first AP via the first link operating as non-PS link, and cause the second STA to communicate with the second AP via the second link operating as PS link.

In some embodiments, the non-PS link is in awake state and the PS link alternates between the light PS mode and the non-PS mode.

In some embodiments, the second AP is in doze state, wherein the processor is further configured to cause the first STA to transmit a trigger frame to the first AP on the first link to wake up the second AP, receive a frame from the second AP that indicates that the second AP is in awake state, and cause the second STA to communicate with the second AP on the second link.

In some embodiments, the processor is further configured to: receive, from the first AP, latency sensitive traffic for the second STA at the first STA via the first link when the second STA is in doze state in the second link, and transition the second STA from doze state to awake state.

In some embodiments, the processor is further configured to transmit a request frame to the AP device requesting reconfiguration for non-PS link and PS link on at least one link between the non-AP device and the AP device, and receive a response frame from the AP device indicating reconfiguration for non-PS link and PS link on the at least one link between the non-AP device and the AP device.

In some embodiments, a primary channel of a link operating as non-PS link is the same as a primary channel of a link operating as non-PS link in a neighboring AP device.

In some embodiments, a primary channel of a link operating as a non-PS link is a part of the operational bandwidth of a link operating as non-PS link in a neighboring AP device.

In some embodiments, latency sensitive traffic or emergency preparedness communications service (EPCS) traffic is communicated on a link operating as non-PS link.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates an example of power save opportunities for an AP in accordance with an embodiment.

FIG. 5 illustrates an information element that can include information to advertise an AP power save capability in accordance with an embodiment.

FIG. 6 illustrates dynamically changing active links over time in accordance with an embodiment.

FIG. 7 illustrates a trigger dependent user info subfield format for a trigger in accordance with an embodiment.

FIG. 8 illustrates usage of a trigger frame on extended power save duration mode in accordance with an embodiment.

FIG. 9 illustrates usage of a trigger frame for shortened power save duration mode in accordance with an embodiment.

FIG. 10. Illustrates a sub-field variant of an A-control sub-field in accordance with an embodiment.

FIG. 11 illustrates an A-control sub-field variant during extended power save mode in accordance with an embodiment.

FIG. 12 illustrates an example of an A-control sub-field variant during shortened power save mode in accordance with an embodiment.

FIG. 13 illustrates a flow chart of an example process of neighbor AP assisted medium synchronization recovery in accordance with an embodiment.

FIG. 14 illustrates an example flow chart of an AP process to request assistance in accordance with an embodiment.

FIG. 15 illustrates an information element for a medium synchronization assistance request in accordance with an embodiment.

FIG. 16 illustrates an information element for medium synchronization assistance response in accordance with an embodiment.

FIG. 17 illustrates beacon based medium synchronization assistance request and response operation in accordance with an embodiment.

FIG. 18 illustrates neighbor AP assisted medium synchronization recovery in accordance with an embodiment.

FIG. 19 illustrates an example process for STA assisted medium synchronization recovery in accordance with an embodiment.

FIG. 20 illustrates a control subfield variant of an A-control subfield in accordance with an embodiment.

FIG. 21 illustrates A-control subfield usage for medium synchronization recovery assistance from a non-AP MLD in accordance with an embodiment.

FIG. 22 illustrates a state check frame format in accordance with an embodiment.

FIG. 23 illustrates a beacon format to advertise capability support in accordance with an embodiment.

FIG. 24 illustrates an information element that can include announcement information in accordance with an embodiment.

FIG. 25 illustrates transmission of an information element in beacon frames in accordance with an embodiment.

FIG. 26 illustrates an exchange of information about affiliated APs on power save (PS) and non-PS links in accordance with an embodiment.

FIG. 27 illustrates a multi-link setup for AP MLD with PS links in accordance with an embodiment.

FIG. 28 illustrates multi-link setup for AP MLD with non-PS links in accordance with an embodiment.

FIG. 29 illustrates negotiation for non-PS and PS links in accordance with an embodiment.

FIG. 30 illustrates negotiation request frame format in accordance with an embodiment.

FIG. 31 illustrates a negotiation response format in accordance with an embodiment.

FIG. 32 illustrates a modified STA control field of a reconfiguration multi-link element in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11bc. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

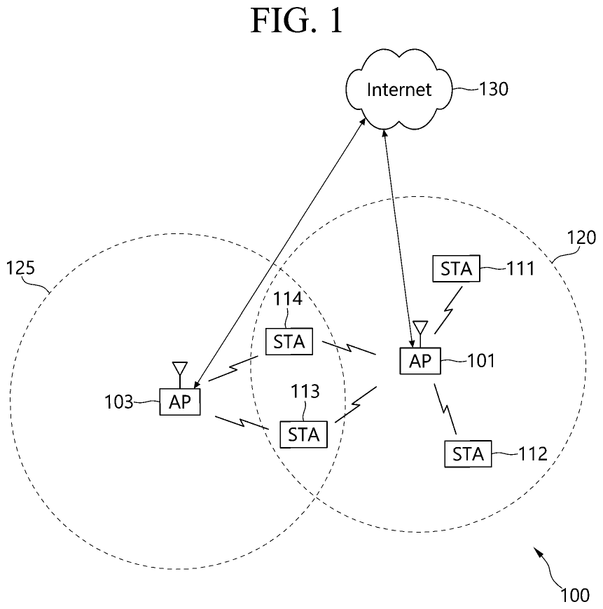

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

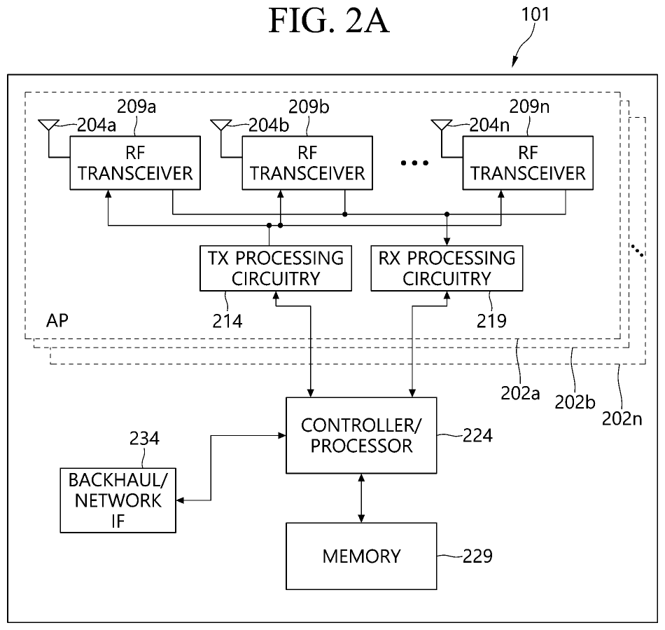

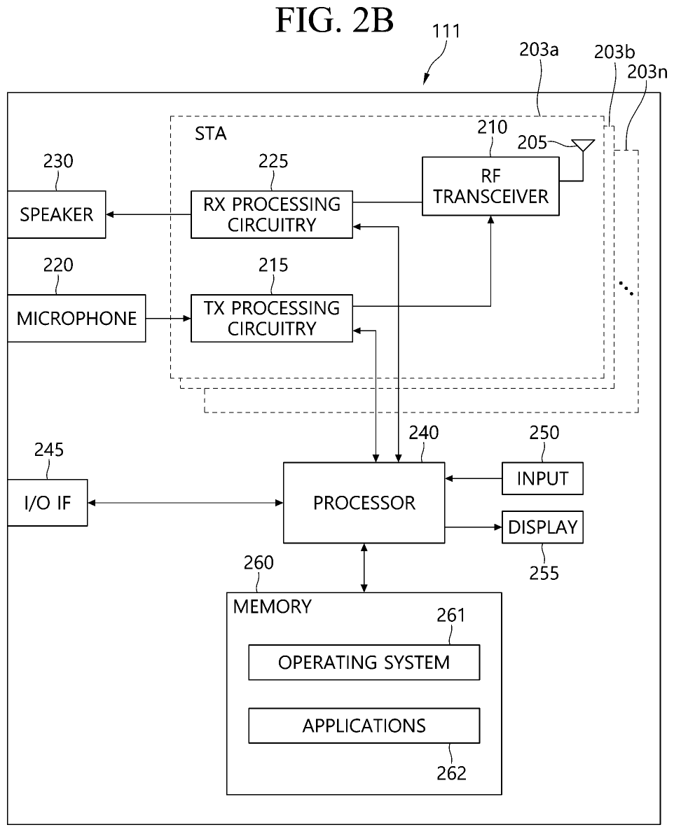

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

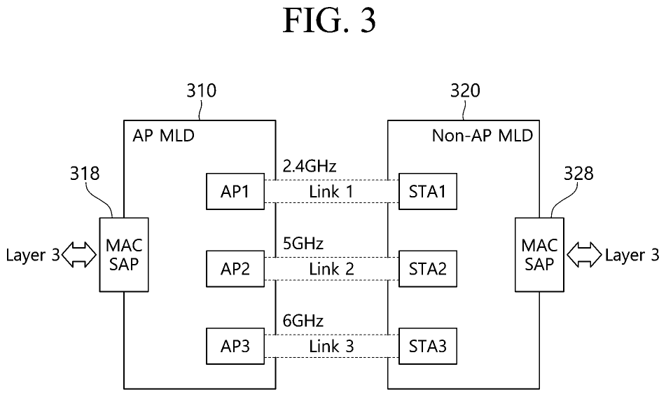

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications” and ii) IEEE P802.11bc/D3.0, “Wireless LAN Medium Access Control (MAC) and Physical Layer (PHY) Specifications.”

IEEE 802.11be introduced multi-link operation as a means to enhance device performance. A multi-link device (MLD) can include one or more affiliated STAs. Thus, an AP MLD can have one or more affiliated AP STAs and a non-AP MLD can have one or more affiliated non-AP STAs. In multi-link operation, devices can transmit traffic concurrently on more than one link thereby increasing the channel access probability. MLD operation may leverage the three bands of operation in wireless networks, which are 2.4 GHZ, 5 GHZ and 6 GHz band.

The IEEE 802.11be standards included certain legacy power save modes, which have been primarily targeted at enabling an STA (i.e., non-AP STA) to conserve power. Different power modes can be specified with legacy power save, including a normal/active mode, doze mode, among others.

An STA may operate and switch between different modes: including switching between the ‘awake’ state and the ‘doze’ state. In the ‘awake’ state, an STA of a non-AP MLD can continuously monitor a channel and transmit and receive packets. In the ‘doze’ state, the STA is not expected to be able to transmit or receive packets.

Various power save modes have been defined and used in the IEEE 802.11 standard, including the normal power save (PS) mode, automatic power save delivery (APSD), wireless network management (WNM) power save mode, power-save multi-poll mode, spatial multiplexing PS, independent basis service set (IBSS) power save, very high throughput (VHT) TXOP power save, among others. In the PS mode, in order to indicate to the AP MLD that a STA is changing its power management mode from active mode to PS mode, a STA may transmit a physical layer protocol data unit (PPDU) with the power management (PM) bit in the frame control field set to 1. Similarly, when a STA intends to change its power management mode from PS mode to active mode, it may send a PPDU to the associated AP with the PM bit in the frame control field set to 0.

When a STA is in the PM mode and its state is in a doze state, the corresponding AP of the AP MLD may buffer “buffer-able packets” that are addressed to the STA and that may not be delivered to another STA affiliated with the same non-AP MLD that is in the awake state. Such buffered packets may be referred to as buffered units (BUs) and may be delivered when the STA returns to the awake state.

An AP may indicate to one or more of the associated non-AP devices about such pending BUs via a broadcast or multi-cast signaling. Each AP of the AP MLD may transmit beacon frames that may periodically include a traffic information map (TIM) element and, optionally, also a multi-link traffic indication element. Each AP of the AP MLD may also additionally transmit these elements as a separate periodic broadcast TIM frame. The non-AP device may know about pending traffic buffered at the AP by listening to the TIM element and/or multi-link traffic indication element in a beacon frame.

A STA affiliated with a non-AP device may transmit a frame (e.g., a PS poll, U-APSD trigger frame among others) to indicate to an AP that it is in the awake state and ready to receive data. Such an indication may not be required for a STA to send a packet in the uplink direction. When an AP affiliated with an AP MLD receives a PS-Poll frame or an unscheduled automatic power save delivery (U-APSD) trigger frame from a STA affiliated with an associated non-AP MLD that is in power save mode, the AP can transmit buffered BU(s) to the STA. The buffered BU(s) can be transmitted to the STA if the BU(s) are available and not otherwise discarded for implementation dependent reasons. For example, the BUs may be discarded for various implementation specific reasons, including buffer overload conditions, delay tolerance exceeding a threshold, among others. If the BU(s) are not available or have been discarded, the STA may transmit a quality of service (QOS) Null frame. After initiating a frame exchange sequence with a STA of a non-AP MLD that is in power save mode to transmit BUs, the affiliated AP of the AP MLD may use a more data subfield in a frame control field of a transmitted data frame to indicate to a non-AP STA whether more individually addressed BUs are buffered for that non-AP MLD. The indicated buffered BUs, which may not include the BU currently being transmitted, may be buffered at the AP MLD for the non-AP MLD and correspond to data frames with TIDs that are mapped to this link or management frames that are not a transmit power control (TPC) request frame or a link measurement request frame. If no such frames are pending, which may be determined if the more data subfield is set to 0, then the STA of the non-AP MLD can go back to doze state after the end of the frame exchange sequence.

Some embodiments may include power saving for the AP. APs have generally been expected to be in active mode of operation. As APs have to be in active mode all the time, the amount of power consumption from an AP may be much higher. This may lead to an increase in network maintenance cost due to energy costs, increases in ecological footprint of the deployed network and battery life reduction in case of battery powered APs. As IEEE 802.11be has introduced MLDs, these costs can linearly increase with increasing number of AP STAs on an AP MLD. Further, in enterprise networks where there can be many co-deployed AP MLDs in an area, the cost per AP MLD can increase. Thus, for reducing maintenance cost and for energy savings, it can be important to consider power save option for APs as well. In the next generation of WLAN, two types of power save modes for AP can be considered, including: (1) scheduled PS mode which may provide for an ON-OFF duty cycling to save AP power and (2) dynamic PS mode where the AP can be in a light PS mode by going to a listen mode instead of the active mode. A light PS mode may be where the AP is operating in a reduced capacity where it may only try to decode certain basic frames. If there is an ongoing transmission, the AP can switch to a higher power mode.

Some embodiments can include a cross link wake up request to help improve energy savings. In particular, when an AP affiliated with an AP MLD transitions from the doze state to the awake state, there can be opportunities for the AP to perform extra energy conservations by staying in the doze state longer. For example, it is possible that the AP does not have any DL traffic to transmit to the STAs affiliated with non-AP MLDs that form a link with the AP. It is also possible that the STA that forms a link with the AP does not have any traffic to transmit to the AP on the UL. In such a case, procedures that can enable the AP to stay in doze state longer to take advantage of this opportunity can help enhance energy savings for the AP.

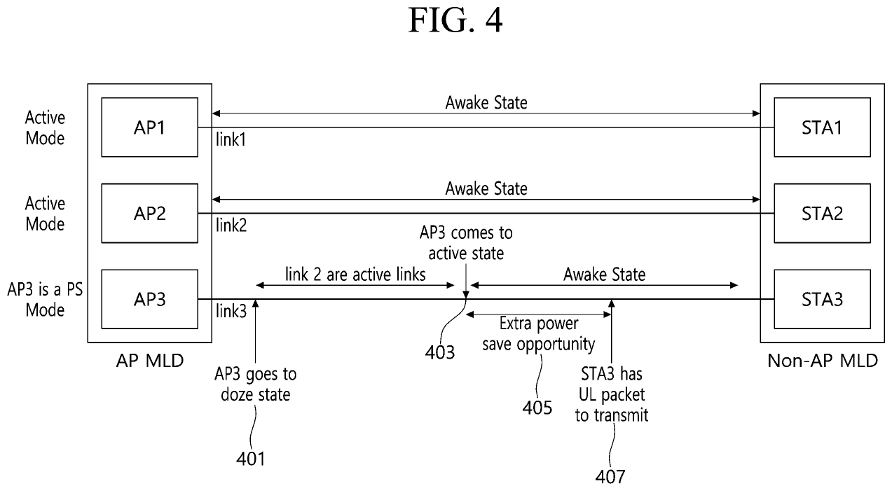

FIG. 4 illustrates an example of power save opportunities for an AP in accordance with an embodiment. As illustrated, AP MLD includes affiliated APs (AP1, AP2 and AP3) and non-AP MLD includes affiliated STAs (STA1, STA2, and STA3). AP1 and AP2 are in the active mode on link 1 and link 2, and AP3 is in a power save (PS) mode on link 3 by going into a doze state at a first time 401. The AP3 transitions from the doze state to the awake state at a second later time 403. However, there is an extra power save opportunity 405 during which AP3 could have remained in the doze state until the time at which STA3 has a UL packet to transmit 407. Accordingly, some embodiments can enable the AP to stay in the doze state until an event occurs that requires performance of the AP.

In some embodiments, when an AP affiliated with an AP MLD is in doze state, there can be a need to wake the AP earlier to enhance the performance of non-AP MLDs associated with the AP MLD. As an example, when an AP is in doze state, it is possible that an STA affiliated with a non-AP MLD that forms a link with this AP has to transmit some frame on the current link due to congestion or overload on the other links. If the AP can wake up early and transition to awake state to serve STA's traffic, this can enhance the STA's performance. Accordingly, some embodiments may enable the AP to transition to awake state earlier to improve the performance of the STA which may help to enhance performance for non-AP MLDs.

Some embodiments can perform medium synchronization recovery using link management for efficient power save. In particular, when an AP performs a power save, and after the AP transitions to the doze state, the AP can lose medium synchronization. As such, after transitioning back to the awake state, the AP may need to perform medium synchronization recovery. Accordingly, the efficient and speedy medium synchronization recovery of the AP may be necessary for the link to start operating. Accordingly, some embodiments can enable the AP to perform medium synchronization recovery using link management for power save.

An AP MLD that performs power save can be associated with one or more non-AP MLDs that do not support power save procedures for APs or are unable to react to AP signaling for power saving for APs (e.g., legacy non-AP MLDs). Accordingly, such non-AP MLDs may not be able to adapt and/or react when an AP affiliated with an AP MLD goes to the doze state. As such, to perform the power save for APs, additional procedures may be necessary.

Some embodiments can include a cross link wake up request. In particular, in some embodiments, an AP can support an extended power save mode operation, where the AP can opportunistically save more power by continuing to stay in the doze state beyond an indicated doze state duration. The AP can remain in the doze state until there is a need to wake up, such as upon receiving a wake-up request from one or more STAs. Likewise, in some embodiments, an AP can support a shortened power save duration mode of operation, where the AP can be woken up earlier than an indicated doze state duration. For example, the AP can be woken up to serve the STA's traffic.

In some embodiments, an AP MLD that supports power save operation can make an advertisement of its capability to support such a feature. An AP MLD may also advertise its capability to support power save operations, including extended power save mode operation and/or shortened power save duration mode of operation. An AP MLD may advertise the capability to support save modes of operation in one or more frames transmitted to the non-AP MLD. The frame transmitted to advertise these capabilities to the non-AP MLD can include the information items described in Table 1.

TABLE 1
Information items that can be present in capability advertisement frame

| Information item | Description |
|---|---|
| AP power save | An information item to indicate that the AP MLD has power save mode |
| support info | supported. e.g., a bit that can be set to 1 to indicate the support for the |
| | feature. |
| Power save link info | An information item to indicate the affiliated AP(s) that have power save |
| | mode supported. e.g., link ID bitmap in which the bits corresponding to |
| | links created by power save APs are set to 1 and the rest are set to 0. |
| Active link info | An AP MLD that supports power save mode on one or more of its |
| | affiliated APs, can keep at least one link as an active link to support |
| | transmission of essential control and management frames, support legacy |
| | STAs that do not have power save mode capabilities, handle low latency |
| | traffic, among others. An information item may be used to indicate the |
| | links on which the AP will remain in the active mode. Such links may |
| | stay in the awake state all the time. e.g., indicated via a link ID bitmap |
| AP extended power | An information item to indicate that the AP MLD supports extended |
| save support | power save mode. e.g., a bit that can be set to 1 to indicate the support |
| | and 0 to indicate that it is not supported. |
| Link info for | An information item to indicate the links on which the AP supports |
| extended power | extended power save. e.g., a link ID bitmap in which the bits for links |
| save support | corresponding to APs that will be active can be set to 1 and the others can |
| | be set to 0. |
| Max extension | An information item to indicate how long can the AP extend its sleep for. |
| duration | e.g., time information indicated in units of TUs. |
| Shortened | An information item to indicate that the AP supports shortened power |
| power | save mode. e.g., a bit that can be set to 1 to indicate the support. |
| save mode support | |
| Link info for | An information item to indicate the link on which the AP supports |
| shortened power | shortened power save. e.g., a link ID bitmap in which the bits |
| save support | corresponding to links on which the AP supports shortened power save |
| | can be set to 1 and the other bits can be set to 0. |
| Time for state | An information item in which the AP can indicate the amount of time it |
| switch upon cross | needs to wake up after a cross link trigger frame is sent by the STA. e.g., |
| link indication | time in microseconds or an encoding to indicate this timing. |

In some embodiments, an AP can transmit the information set forth in Table 1 in an independent frame and/or in any of the frames existing in the IEEE 802.11 standards (e.g., beacon frames among others).

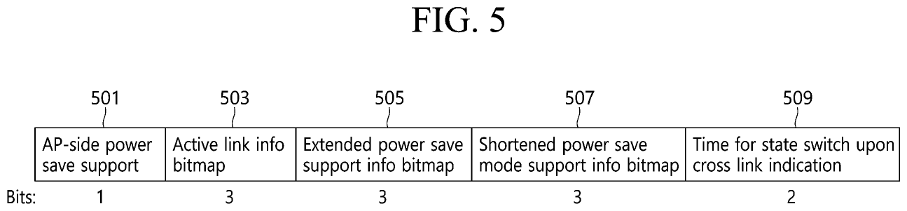

FIG. 5 illustrates an information element that can include information to advertise an AP power save capability in accordance with an embodiment.

As shown in FIG. 5, the information element 500 includes an AP-side power save support field 501, an Active link info bitmap field 503, an Extended power save support info bitmap field 505, a Shortened power save mode support info bit map field 507, and a Time for state switch upon cross link indication field 509.

The AP MLD can transmit the information element in management frames, including a beacon frame, a probe response frame, among other types of frames that the AP MLD transmits to the non-AP MLD. A non-AP MLD that receives such a frame can understand the AP support for power save, which may assist the STA in initiating the necessary procedures to coordinate with the AP power save operation. Although not illustrated in FIG. 5, it will be appreciated that some embodiments can also include various basic fields, including an element ID, length and element ID extension, among other fields.

In some embodiments, the AP-side power save support bit 501 can be set to 1 when the AP MLD has at least one or more APs affiliated with it that support power save. The active link info bitmap 503 may indicate the links on which the corresponding APs will stay in active mode. A value of 1 in bit position i of the bitmap may indicate to the non-AP MLD that the AP affiliated with the AP MLD operating on the link with link ID equal to i can stay in active mode and not perform power save. A value of 0 in bit position i of the bitmap may indicate to the non-AP MLD that the AP affiliated with the AP MLD operating on the link with link ID equal to i can perform power save.

The extended power save support info bitmap 505 can indicate the links on which the extended power save mode is supported. A value of 1 in bit position i of the bitmap can indicate to the non-AP MLD that the AP affiliated with the AP MLD operating on the link with link ID equal to i can support extended power save mode. A value of 0 in the bit position i of the bitmap can indicate to the non-AP MLD that the AP affiliated with the AP MLD operating on the link with link ID equal to i cannot support extended power save mode. In some embodiments, if an AP affiliated with an AP MLD supports power save but does not support extended power save, then the AP can wake up at the indicated point in time and not perform extended power save.

The shortened power save mode support info bitmap 507 can indicate the links on which the shortened power save mode is supported. A value of 1 in the bit position i of the bitmap can indicate to the non-AP MLD that the AP affiliated with the AP MLD operating on the link with link ID equal to i can support shortened power save mode. A value of 0 in the bit position i of the bitmap can indicate to the non-AP MLD that the AP affiliated with the AP MLD operating on the link with link ID equal to i cannot support shortened power save mode. If an AP affiliated with an AP MLD supports power save but does not support extended power save, then it may not be woken up by the STA before its indicated doze period is completed.

The time for state switch upon cross link indication 509 can be a bit value (e.g., a two-bit value) that can follow an encoding to indicate the time to switch states at the AP upon cross link wake up indication from the STA. In some embodiments, the values of this field (e.g., 2-bit field) can take a particular time value that can be set according to a time that the hardware takes to go from the doze to the awake state after receiving the wake up request from the STA.

In some embodiments, a non-AP MLD may advertise its support for procedures that may be necessary to coordinate with an AP power save operation. The non-AP MLD may transmit its support in one or more frames that it transmits to the AP (e.g., beacon frames, probe request frame, among others). The information element that the non-AP MLD transmits to advertise its support can include at least one or more of the information items that are indicated in Table 1. In some embodiments, an information element, such as the information element described in FIG. 5, can be used by the non-AP MLD. The fields that correspond to AP MLD side features can be ignored by the AP MLD when such an information element is received from a non-AP MLD (e.g., time for state switch upon cross link indication, among others).

When the non-AP MLD makes use of an information element, the fields can carry the information as follows. When non-AP supports procedures to coordinate AP power save mode, it can set the AP-side power save support 501 bit to 1. The active link info bitmap 503 can be unused when the STA makes the capability advertisement. Extended power save support info bitmap 505 can indicate the links on which the STA can send the cross link wake up request to the AP or can be left unused. Likewise, shortened power save mode support info bitmap 507 can indicate the links on which the STA can send the cross link wake up request to the AP or can be left unused. Time for state switch upon cross link indication 509 can indicate the time the STA takes to switch from the doze state to the awake state when the AP sends a cross link wake up request to the STA.

In some embodiments, the non-AP MLD can advertise its capability to support power save which can enable the AP MLD to know which STAs are capable and/or if all the STAs on a given link are capable of supporting power save. If one or more STAs on a given link, affiliated with different non-AP MLDs, are not capable of supporting AP power save related procedures, then the AP can disable the PS mode on that particular link.

Some embodiments can provide active link management for power save. In some embodiments, the AP MLD can keep one of the APs in active mode. An AP on a particular link can be kept in active mode by disabling power save mode for that AP. The corresponding AP can thus always stay in active mode for transmission or reception. In some embodiments, the AP can be useful for transmission of essential frames (e.g., beacon frames, probe responses, association related frames, discovery, among others) when other APs affiliated with the same AP MLD perform power save. The low latency traffic of non-AP MLDs can also be mapped to this link so that the low latency traffic does not suffer from latency issues due to power save of the AP where the power save mode is enabled.

The AP MLD can keep the one or more active links fixed and announce the links and/or the affiliated APs that do not perform power save to the associated non-AP MLDs. The announcement can be included in a frame that the AP MLD transmits to the non-AP MLDs, including management frames such as beacon frames, probe responses, among others.

In some embodiments, the AP MLD can keep at least one of its affiliated APs in the active mode at a time and announce which AP will stay in the active mode as the other APs are in the sleep mode. The AP can provide this information in one or more frames that it transmits to the non-AP MLDs. Thus, the active link can change over a period of time based on the announcement.

In some embodiments, AP MLD can keep one AP active at a time and the others in sleep mode when certain conditions are satisfied. For example, a condition can include that all the associated non-AP MLDs support necessary procedures for handling the AP STA's power save operation and there is a default TID to link mapping. In some embodiments, a change in active link over time can be useful for multi-link interference management while conserving power. In some embodiments, APs affiliated with different AP MLDs but interfering with each other can perform power save in a time division duplex (TDD) manner to avoid interference to each other.

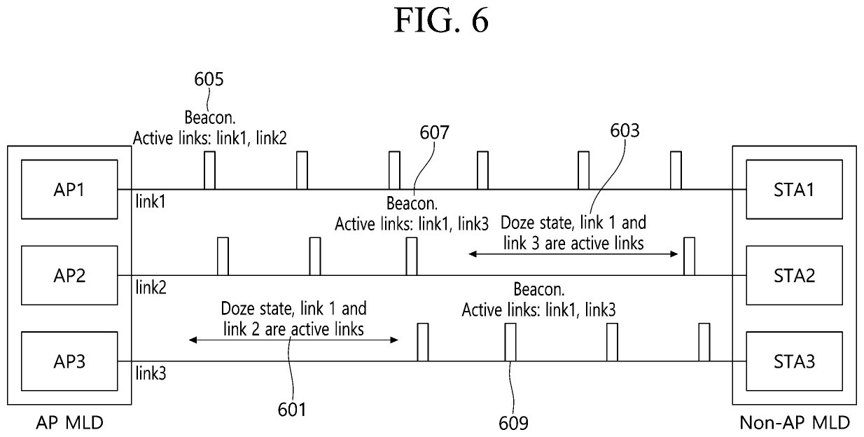

FIG. 6 illustrates dynamically changing active links over time in accordance with an embodiment. In particular, AP MLD includes affiliated APs, AP1, AP2 and AP3 and non-AP MLD includes affiliated STAs, STA1, STA2, and STA3. During a first time period 601, link 1 and link 2 can be active links while link 3 is in a doze state. A beacon frame 605 can be transmitted on link 1 to indicate that the active links are link 1 and link2.

During a second time period 603, link 1 and link 3 can be the active links while link 2 is in the doze state. A beacon frame 607 can be transmitted during the first time period 601 on link 2 to indicate that link 1 and link 3 are the active links.

During the second time period 603, a beacon frame 609 can be transmitted on link 3 to indicate that link 1 and link 3 are the active links.

In some embodiments, AP MLD and non-AP MLD can negotiate an active link on which they both may need to be active. This can be useful when both the sides perform power save and want to perform power save independently on each of the links.

Some embodiments can include a cross link wake-up request. In some embodiments, when an AP has no need to wake up, then the AP can continue to stay in doze state beyond its intended duration, which can be indicated to the STA beforehand. A need to wake up may occur, for example, when the AP has no downlink traffic buffered for any of the STAs, has traffic that is not latency sensitive mapped to it, or has default TID to link mapping.

In some embodiments, the STA can send a request frame to wake up the AP in a cross link manner. In particular, an STA affiliated with a non-AP MLD can transmit a request frame to wake up an AP affiliated with an AP MLD. The request frame can be transmitted via one or more of the STAs affiliated with the same non-AP MLD to one or more of the APs affiliated with the same AP MLD.

In some embodiments, when the STA needs an AP to wake up earlier than the intended doze state duration, which may be indicated to the STA beforehand, then the STA can transmit a request frame to wake up the AP in a cross link manner. An STA affiliated with a non-AP MLD may transmit a request frame to wake up an AP affiliated with an AP MLD. The request frame can be transmitted via one or more of the STAs affiliated with the same non-AP MLD to one or more of the APs affiliated with the same AP MLD. In some embodiments, the cross link wake up request mechanism can be useful when there is non-default TID to link mapping. In some embodiments, the STA may request the state to which the AP needs to wake up to such as an awake state, a listen state, among others.

In some embodiments, when the AP receives a cross link wake up request from the STA, the AP can transition out of the doze state to the appropriate state (e.g., transition from doze to awake state or transition from doze to listen state).

The cross link wake up request frame transmitted by the non-AP MLD may include at least one or more of the information items as indicated in Table 2.

TABLE 2
Information items that can be present in the cross
link wake up request transmitted by the non-AP MLD

| Information | |
|---|---|
| item | Description |
| Link info | An information item to indicate the link(s) for which the APs need to wake |
| | up. e.g., link ID bitmap |
| Traffic info | An information item to indicate the TID(s) that are buffered for the uplink |
| | on each of these links that needs to wake up. e.g., a TID bitmap |
| Wake up | The time by which the STA wants the AP to wake up. Can be one duration |
| deadline | per link. e.g., timing indicated in a certain unit (e.g., microseconds). |
| Triggering | The STA can indicate if there is a need to trigger the STA to collect STA's |
| requirement | UL backlog or not. e.g., a bit that can be set to 1 to indicate that the STA |
| info | needs such a support from the AP after waking up. If the AP has no DL |
| | traffic for the STA and STA does not have any triggering need and can |
| | transmit the frame to the AP, then the AP can wake up and transition to |
| | listen state instead of awake state for some more power saving. |
| Frequency | Any requirements on the frequency resources that are needed for the STA's |
| resource | uplink transmission. |
| assignment | |
| Wake up state | The state to which the AP should wake up to. e.g., awake state or listen state. |
| info | e.g., this can be a bit value that can be set to 1 to indicate awake state and 0 |
| | to indicate listen state. |

The information in Table 2 can be carried in an independent frame or other types of frames in the IEEE 802.11 standard.

In some embodiments, when an AP is in doze state, a cross link trigger frame can be transmitted to wake up the AP. This can be a new type of trigger frame. The trigger type sub-field in the common info field of the trigger frame can take one of the currently reserved values. The trigger dependent user info subfield format for a trigger frame can include one or more of the information items as indicated in Table 2.

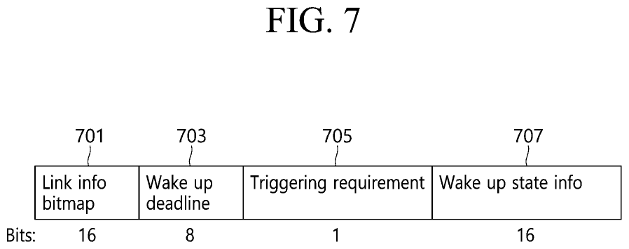

FIG. 7 illustrates a trigger dependent user info subfield format for a trigger in accordance with an embodiment. As shown in FIG. 7, the trigger dependent user info subfield includes a Link info bitmap field 701, a Wake up deadline field 703, a Triggering requirement field 705, and a Wake up state info field 707.

The link info bitmap field 701 can indicate the links on which the APs may need to wake up. A value of 1 in bit position i of the bitmap can indicate to the AP MLD that the AP affiliated with that AP MLD operating on the link with link ID equal to i needs to come out of doze state. A value of 0 in bit position i of the bitmap can indicate to the AP MLD that the AP affiliated with the AP MLD operating on the link with link ID equal to i can maintain its current state.

The wake up deadline 703 can be a duration in microseconds within which the APs indicated in the link info bitmap may need to wake up. The triggering requirement subfield 705 can be set to 1 if the STA needs the AP to wake up and trigger the STA for UL transmission and 0 if no such requirement is necessary.

The wake up state info 707 can indicate the state to which the STA wants the AP to wake up to. A value of 1 in bit position i of the bitmap can indicate to the AP MLD that the AP affiliated with that AP MLD operating on the link with link ID equal to i needs to transition to awake state if that AP affiliated with the AP MLD is also indicated in the link info bitmap. A value of 0 in bit position i of the bitmap can indicate to the AP MLD that the AP affiliated with the AP MLD operating on the link with link ID equal to i can transition to listen state if that AP affiliated with the AP MLD is also indicated in the link info bitmap.

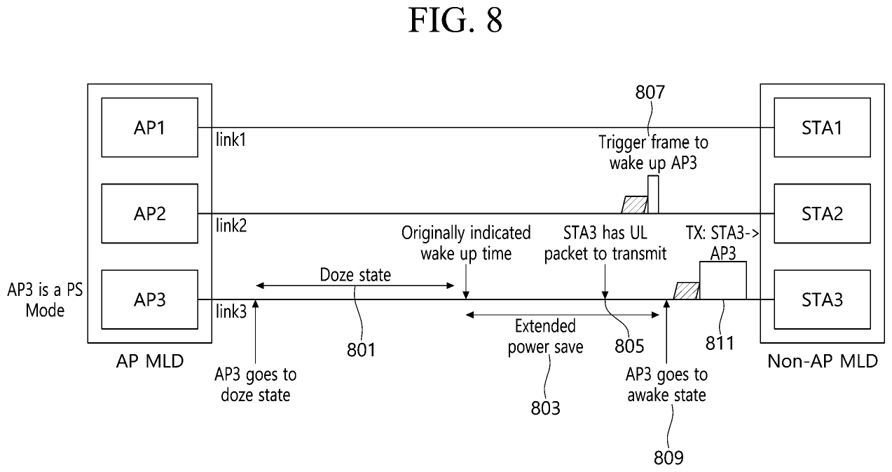

FIG. 8 illustrates usage of a trigger frame on extended power save duration mode in accordance with an embodiment. As illustrated AP MLD includes AP1, AP2, and AP3 and non-AP MLD includes STA1, STA2 and STA3. AP3 is a PS mode supporting AP. During a first time 801, AP3 is in doze state and extends its doze state by a second time period 803 beyond the indicated time to save extra power. Meanwhile, STA3 has a UL packet to transmit at a third time 805 that gets buffered at STA3. A trigger frame 807 is transmitted to wake up AP3 on link 2. The trigger frame is transmitted by STA2 to AP2. Upon receipt of the trigger frame, AP3 wakes up 809. AP3 may also wake up and transmit a frame (e.g., beacon frame, among others) to announce that it has woken up. Such a frame is not shown in the figure but can be present. Following this, STA3 transmits its uplink data 811 to AP3.

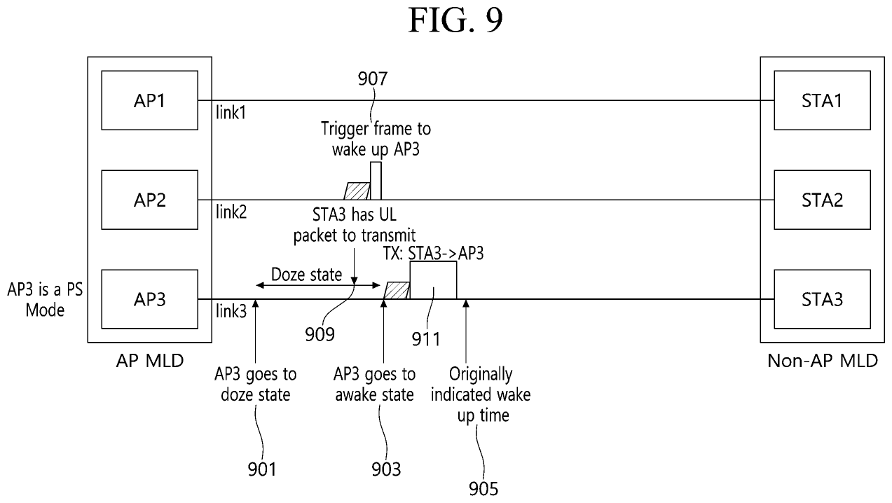

FIG. 9 illustrates usage of a trigger frame for shortened power save duration mode in accordance with an embodiment. As illustrated AP MLD includes AP1, AP2, and AP3 and non-AP MLD includes STA1, STA2 and STA3. AP3 is a PS mode supporting AP. At a first time 901, AP3 is in doze state and has an original indicated wake up time 905. Meanwhile, STA3 has a UL packet to transmit 909 that gets buffered at STA3 side. A trigger frame 907 is transmitted to wake up AP3 on link 2 before its indicated wake up time. The trigger frame is transmitted by STA2 to AP2. Upon receipt of the trigger frame, AP3 wakes up 903. AP3 can also wake up and transmit a frame (e.g., beacon frame) to announce that it has woken up (not shown in figure). Following this, STA3 transmits 911 its uplink data to AP3.

In some embodiments, when an AP is in doze state, non-AP MLD can transmit a control sub-field variant of an A-control sub-field on one or more of the active links. In some embodiments, this can be done by including the A-control sub-field in the PPDU being transmitted on one of the active links, by transmitting a QoS Null frame, among other techniques. The control sub-field variant of an A-control sub-field can include at least one or more of the information items as indicated in Table 2.

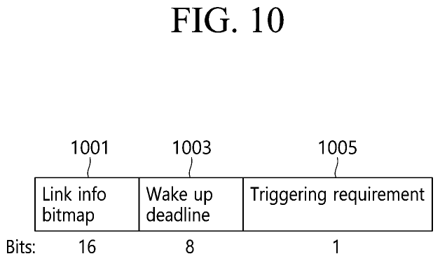

FIG. 10 illustrates a sub-field variant of an A (aggregated)-control subfield in accordance with an embodiment. The subfield variant of an A-control subfield includes Link info bitmap field 1001, Wake up deadline field 1003, and Triggering requirement field 1005.

The link info bitmap field 1001 can indicate the links on which the APs may need to wake up. The wake up deadline field 1003 can be can be a duration in microseconds within which the APs indicated in the link info bitmap may need to wake up. The triggering requirement field 1005 can be set to 1 if the STA needs the AP to wake up and trigger the STA for UL transmission and 0 if no such requirement is necessary.

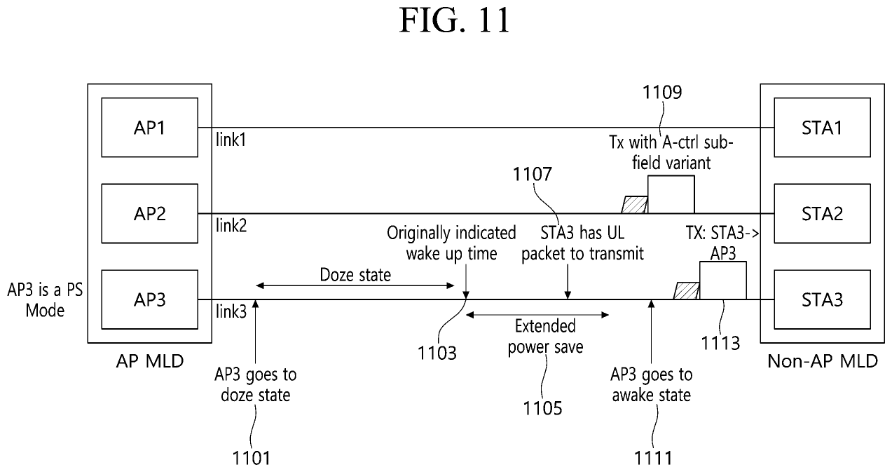

FIG. 11 illustrates usage of the A-control sub-field variant during extended power save mode in accordance with an embodiment. As illustrated, AP MLD includes AP1, AP2, and AP3 and non-AP MLD includes STA1, STA2 and STA3. AP3 is a PS mode supporting AP. During a first time 1101, AP3 is in doze state and extends its doze state by a second time duration 1105 beyond the original indicated wake up time 1103 to save extra power. Meanwhile, STA3 has a UL packet 1107 to transmit that gets buffered at STA3 side. STA2 has an ongoing transmission 1109 and the A-control sub-field is included in this transmission to AP2. Based on the link info bitmap which indicates link 3 to be woken up, AP3 is woken up at a third time 1111. AP3 can also wake up and transmit a frame (e.g., beacon frame, among others) to announce that it has woken up (not shown in the figure). Following this, STA3 transmits its uplink data 1113 to AP3.

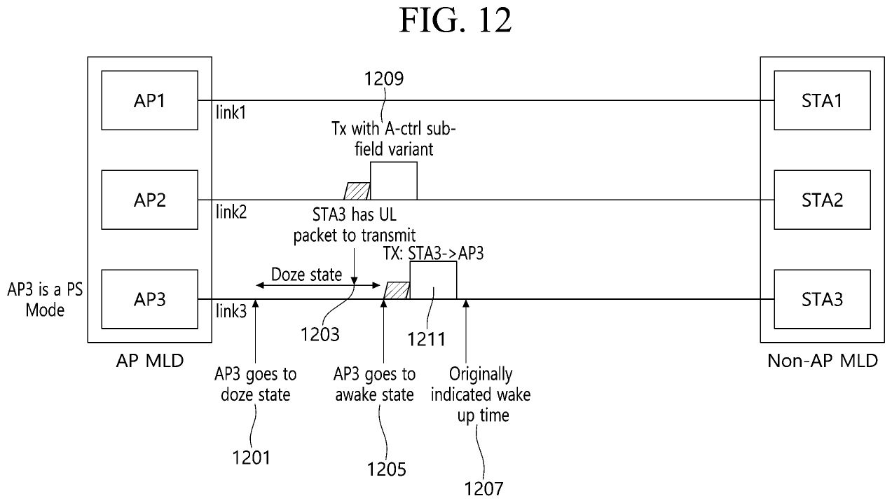

FIG. 12 illustrates an example usage of the A-control sub-field variant during shortened power save mode in accordance with an embodiment. As illustrated AP MLD includes AP1, AP2, and AP3 and non-AP MLD includes STA1, STA2 and STA3. AP3 is a PS mode supporting AP. AP3 is in doze state during a first time 1201 and has an original indicated wake up time 1207. Meanwhile, STA3 has a UL packet 1203 to transmit that gets buffered at STA3 side. STA2 has an ongoing transmission 1209 and the A-control sub-field is included in this transmission to AP2. Based on the link info bitmap which indicates link 3 to be woken up, AP3 is woken up at a second time 1205. AP3 can also wake up and transmit a frame (e.g., beacon frame, among others) to announce that it has woken up (not shown in the figure). Following this, STA3 transmits its uplink data 1211 to AP3 on link 3.

The AP can come out of doze state to any of the states that are being requested by the STA or to any of the states that the AP considers necessary. In some embodiments, when the AP transitions to the awake state, it can transmit a frame to announce to the STAs that it has transitioned to the awake state. For example, upon coming to the awake state, the AP can transmit a beacon frame or start a downlink transmission to an STA that is in awake state.

In some embodiments, when the AP transitions from a doze to a listen state, it can make an announcement on one or more frames transmitted on one or more of the other active links (e.g., in a beacon frame that is transmitted on the active links). Transitioning to the listen state can be useful if the AP does not have any downlink traffic and the AP is solely waiting for the STA to send UL traffic to it. When the AP starts receiving the UL traffic, it can switch to a normal receive state.

The described techniques herein may also be used when an STA performs power save. For example, the AP can transmit a cross link wake up frame to wake up the STA to receive some low latency traffic. In some embodiments, the wake up times may be non-indicated wake times (e.g., only AP knows and wake time is not indicated to STA) or implicitly indicated wake up times (e.g., doze states of TWT).

Some embodiments can include medium synchronization recovery techniques. In some embodiments, when an AP affiliated with an AP MLD has lost medium synchronization, it can start a medium synchronization timer (may be referred to as MediumSyncDelay timer) to assist it in doing medium synchronization recovery. In some embodiments, the AP can set the timer and begin to count down from the time it transitions out of the doze state. For example, the time when it transitions from doze to awake state. The AP can set the timer if the duration of loss of medium synchronization is longer than a certain threshold (e.g., a MediumSyncThreshold). Thus, if the AP stays in the doze state for a period of time that is longer than this threshold, then it can set this timer. Otherwise, it may not set this timer.

The medium synchronization timer can be a single timer that can be shared by all the EDCAFs with the AP. In some embodiments, the AP can use the value that was included in the Medium Synchronization Delay Information field (if such a field was present) in the basic multi-link element in the most recent frame that it transmitted to the STAs. In some embodiments, the AP can use the value that it plans to include in the Medium Synchronization Delay Information field in the basic multi-link element in future frames that it plans to transmit to the STAs. In some embodiments, the AP can use a value that it sees fit for the window of time when it is performing medium synchronization recovery.

An AP can set the timer to zero when (1) the AP receives a physical layer protocol data unit (PPDU) with a valid MAC protocol data unit (MPDU) or (2) the AP receives a PPDU whose corresponding Rx-vector parameter TXOP_DURATION is not UNSPECIFIED.

The medium synchronization recovery can be an assisted recovery. The assistance can be requested from another device. Thus, there can be two types of devices—(1) a requesting device which can be the AP that has lost medium synchronization, or (2) an assisting device which can be the device that can assist the requesting device in medium synchronization recovery.

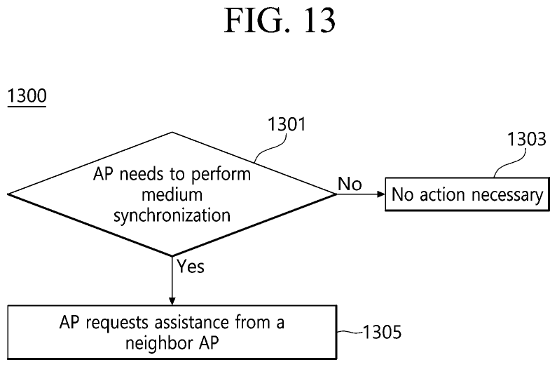

The assisting device can be a neighboring AP. FIG. 13 illustrates a flow chart of an example process of neighbor AP assisted medium synchronization recovery in accordance with an embodiment. The process 1300 can include, in operation 1301, the AP determines whether the AP needs to perform medium synchronization. If the AP determines that it does not need to perform medium synchronization, the process proceeds to operation 1303 where no action is necessary. If the AP determines that it needs to perform medium synchronization, in operation 1305 the AP requests assistance from a neighbor AP.

A neighbor AP can be an AP or an AP affiliated with another AP MLD that the first AP MLD coordinates with for the purpose of Multi-AP (MAP) coordination. The neighbor AP can sense the channel on which the AP that has lost medium synchronization operates. For example, the neighbor AP can operate on the same band/channel as the AP that has lost medium synchronization. In another example, the neighbor AP can either have the same primary channel of operation or the primary channel of the AP that has lost medium synchronization can be a part of the operating bandwidth of the neighboring AP or vice versa.

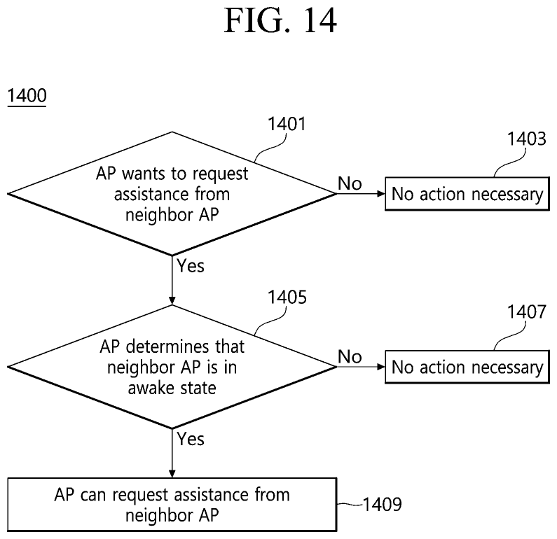

In some embodiments, the requesting AP can make a request from an AP that is in awake state or can wake up the AP to request for assistance. FIG. 14 illustrates an example flow chart of an AP process to request assistance in accordance with an embodiment. The process 1400 performs operation 1401 where the AP determines whether it wants to request assistance from a neighbor AP. If the AP determines that it does not want to request assistance from a neighbor AP, the process performs operation 1403 where no action is necessary. If the AP determines that it does want to request assistance from a neighbor AP, the process performs operation 1405 where the AP determines that the neighbor AP is in the wake state. If the AP determines that the neighbor AP is not in the wake state, the process performs operation 1407 where no action is necessary. If the AP determines that the neighbor AP is in the wake state, the process performs operation 1409 where the AP can request assistance from the neighbor AP.

In some embodiments, APs can share with each other their PS schedules or an indication of a transition to the doze state in advance. A requesting AP can seek assistance from those APs that have conveyed their intention to not transition to the doze state (e.g., through beacon frames, among others). If a neighbor AP is in PS mode, the requesting AP can also wake up the AP via a cross link wake up request. In some embodiments, the AP can also check the state of the neighbor AP via a cross link state check frame and send the request frame for medium synchronization recovery if the AP is in awake state.

In some embodiments, when a requesting device makes a medium synchronization recovery assistance request from a neighboring AP, the requesting device can transmit a request frame that includes at least one or more of the information items as indicated in Table 3.

TABLE 3
information that can be present in the request
frame transmitted by the requesting AP.

| Information | |
|---|---|
| item | Description |
| Reason | An information item that describes the reason for sending the frame. e.g., a |
| information | reason code that can indicate that the reason for sending the frame is to seek |
| | assistance with medium synchronization recovery due to power save of the |
| | AP. |
| Link | An information item that describes the link(s) this assistance is needed on. |
| information | e.g., the link ID, indication via link ID bitmap. |
| Timing | An information item to indicate the time by which the assistance is needed. |
| information | e.g., a timestamp. This information item can enable the requesting AP to |
| | seek assistance within a time limit to ensure speedy recovery and operation |
| | commencement. The timing information can also be provided on a per link |
| | basis. |
| Wake | An information item to indicate the time by which the AP will come out of |
| information | PS mode. The wake information can also be provided on a per link basis. |

The requesting device can transmit a frame to the neighboring AP on one or more of the links on which the neighboring AP operates except the link on which the requesting device has lost medium synchronization.

The information can be carried in an independent frame or other types of frames existing in the IEEE 802.11 standard (e.g., management frames, among others).

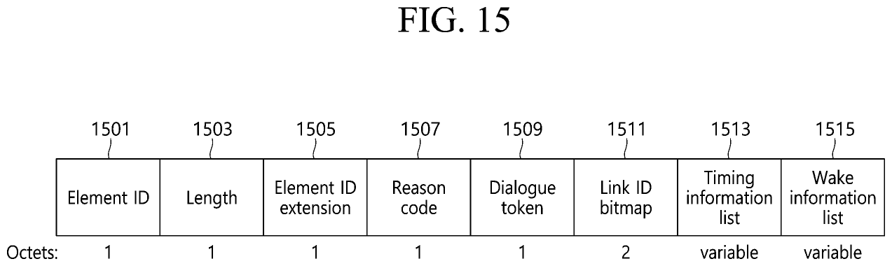

FIG. 15 illustrates an information element for a medium synchronization assistance request in accordance with an embodiment. The information element can include the an Element ID field 1501, Length field 1503, Element ID extension field 1505, Reason code field 1507, Dialogue token field 1509, Link ID bitmap field 1511, Timing information list field 1513, and Wake information list field 1515.

The element ID field 1501 can provide an identifier for the element. The length field 1503 can provide a length of the information element. The element ID extension field 1505 can provide an element ID extension field for the information element.

The reason code field 1507 can indicate the reason for sending the information element (e.g., a value for a code that can indicate that this frame is making a request for medium synchronization assistance).

The dialogue token field 1509 can be a unique integer value generated by the requesting AP and can be used as a reference for this request.

The link ID bitmap field 1511 can indicate the links for which the assistance is needed. A value of 1 in bit position i of the bitmap can indicate to the neighboring AP MLD that the AP affiliated with the requesting AP MLD operating on the link with link ID equal to i needs the support for assisted medium synchronization. A value of 0 in the bit position i of the bitmap can indicate to the neighboring AP MLD that the AP affiliated with the requesting AP MLD operating on the link with link ID equal to i does not need the assistance.

The timing information list field 1513 may be a list of timing information (e.g., each 2 octet long) for each of the links for which assistance is requested in the same order. The wake information list field 1515 may be a list of wake information (e.g., each 2 octet long) for each of the links for which the assistance is requested.

The information element can be carried in one or more of the frames. In some embodiments, the information element can be carried in beacon frames for making a request in cases where the PS is scheduled, in such cases the timing information field can also be tagged with the link ID if there are multiple PS mode transitions scheduled. Neighboring APs that hear such a beacon frame can generate a response frame. In some embodiments, the information element can be carried in an action frame for AP to AP communication. In some embodiments, the information element can be encapsulated in an Ethernet frame and transmitted on the backhaul.

When the neighbor AP receives the request frame, it can process the frame and transmit a response frame to the requesting AP. The response frame can be transmitted on any of the links that the requesting device operates on. The response frame can include at least one or more of the information items described in Table 4.

TABLE 4
information items that can be present in the response
frame transmitted by the assisting AP

| Information | |
|---|---|
| item | Description |
| Reason | An information item that describes the reason for sending the frame. e.g., a |
| information | reason code that can indicate the reason for sending the frame is to agree to |
| | provide assistance with medium synchronization recover due to power save |
| | of the AP. The neighbor AP can also reject the request if it cannot meet the |
| | needs of the requesting AP. |
| Link | An information item that describes the link(s) this assistance can be |
| information | provided on. e.g., the link ID, link ID bitmap. There can be some links on |
| | which the neighboring AP cannot provide assistance. e.g., due to its own |
| | power save operation schedule. Thus, this field can enable the neighboring |
| | AP to make such an indication. |
| Timing | An information item to indicate the time by which the assistance can be |
| information | provided. e.g., a timestamp. The neighboring AP can have some constraints |
| | due to which it can take some time before the neighboring AP can provide |
| | assistance. e.g., this information can be useful to the requesting device to |
| | determine if it can seek assistance from another device or not. |

The information items in Table 4 can be carried in an independent frame or in any of the existing frames in the IEEE 802.11 standard.

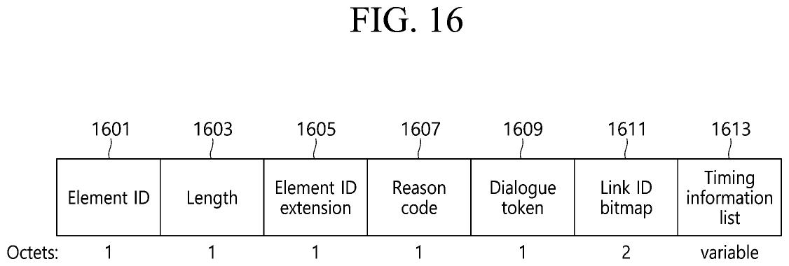

FIG. 16 illustrates an information element for medium synchronization assistance response in accordance with an embodiment. The information element can include an Element ID field 1601, Length field 1603, Element ID extension field 1605, Reason code field 1607, Dialogue token field 1609, Link ID bitmap field 1611, and Timing information list field 1613.

The element ID field 1601 can provide an identifier for the element. The length field 1603 can provide a length of the information element. The element ID extension field 1605 can provide an element ID extension field for the information element.

The reason code field 1607 can indicate the reason for sending the information element (e.g., a value for a code that can indicate that this frame is responding to a request for medium synchronization assistance). The dialogue token field 1609 can be the same dialogue token as carried in the request. The link ID bitmap field 1611 can indicate the links for which the assistance can be provided. A value of 1 in bit position i of the bitmap can indicate to the requesting AP MLD that the responding AP MLD can provide assistance on the link with link ID equal to i needs the support for assisted medium synchronization. A value of 0 in the bit position i of the bitmap can indicate to the requesting AP MLD that the responding AP MLD cannot provide assistance on the link with link ID equal to i (either because assistance was not requested or because it is not possible). The timing information list field 1613 may be a list of timing information (each 2 octets long) for each of the links for which assistance can be provided in the same order. The information element can be carried in one or more of the frames. In some embodiments, when a neighboring AP MLD receives a request for assisted medium synchronization, it can include the response information element in beacon frames that it transmits. In some embodiments, the information element can be transmitted action frames for AP to AP communication. In some embodiments, the information element can also be encapsulated in an Ethernet frame.

In some embodiments, to understand each other's indicated timing information, the APs can synchronize their TSF timers. In some embodiments, each AP can correct the timing information that is provided by the other AP.

In some embodiments, if the neighbor AP agrees to provide assistance to the requesting AP, it can then contend and transmit a frame (e.g., trigger frame, among others) to the neighbor AP on the link on which the assistance is being requested on. Upon receiving the frame, the requesting AP can reset its medium synchronization timer and start its operation.

In some embodiments, the trigger frame transmitted by one AP to another can include the other AP's MAC address in the RA field of the trigger frame. The trigger type in the common info field can be set to one of the currently reserved values to indicate that this is an AP to AP medium synchronization assistance trigger frame.

In some embodiments, the APs that coordinate with each other to provide assistance in medium synchronization recovery can share each other's PS schedule or intention to go into doze state via frames that they transmit (e.g., a new coordination frame or in existing frames such as beacon frames, among others).

In some embodiments, the requesting AP can also request assistance from a non-managed network such as a P2P network, Mobile AP network, among others.

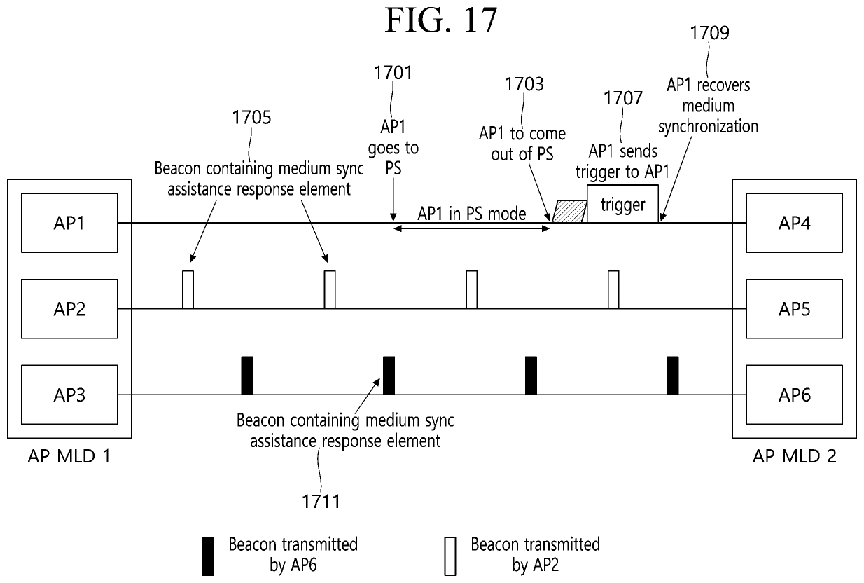

FIG. 17 illustrates beacon based medium synchronization assistance request and response operation in accordance with an embodiment. AP MLD1 and AP MLD2 are two AP MLDs that coordinate with each other and can assist each other in medium synchronization. AP1, AP2 and AP3 are AP STAs affiliated with AP MLD1 and AP4, AP5 and AP6 are AP STAs affiliated with AP MLD2. AP1 intends to go to PS mode at the indicated time 1701 and has an indicated wake time 1703. AP2 transmits beacon frames 1705 that include the medium sync assistance request element. The beacon frame is received by AP5. AP MLD2 can process the request and transmit the response in the beacon frame 1711 that it transmits. Upon receiving the beacon frame, AP MLD1 knows that it will receive assistance from AP MLD2 for medium synchronization recovery of AP1. At the indicated time, AP4 contends for medium access and transmits a trigger frame 1707 to assist AP1 in medium synchronization recovery. The beacon frames transmitted by the two MLDs can be on the same link as well. For example, beacon frame carrying the request can be transmitted by AP2 and beacon frame carrying response can be transmitted by AP5.

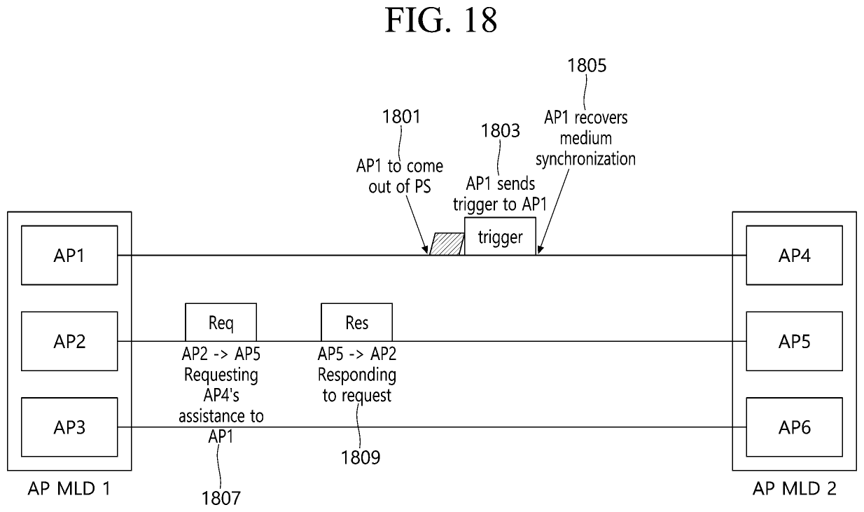

FIG. 18 illustrates neighbor AP assisted medium synchronization recovery in accordance with an embodiment. As illustrated in FIG. 18, the assistance request and response is carried out via AP to AP communication action frames. AP MLD1 and AP MLD2 are two AP MLDs that coordinate with each other and can assist each other in medium synchronization recovery. AP MLD1 includes AP1, AP2, and AP3 and AP MLD 2 includes AP4, AP5, and AP6.

AP1 performs PS and is scheduled to come out of PS at the point indicated 1801. To request for AP4's assistance in medium synchronization recovery for AP1, AP2 affiliated with AP MLD1 transmits a request frame 1807 to AP5. AP5 transmits a response frame 1809 granting the request. Following this, AP4, contends to obtain channel access and transmits a trigger frame 1803 to AP1 following which AP1 recovers medium synchronization 1805.

In some embodiments, the assisting device can be an STA that is associated with the non-AP MLD whose affiliated AP has lost medium synchronization. An AP affiliated with an AP MLD that has lost medium synchronization can make a request from an STA affiliated with a non-AP MLD associated with the AP MLD for assistance in medium synchronization recovery.

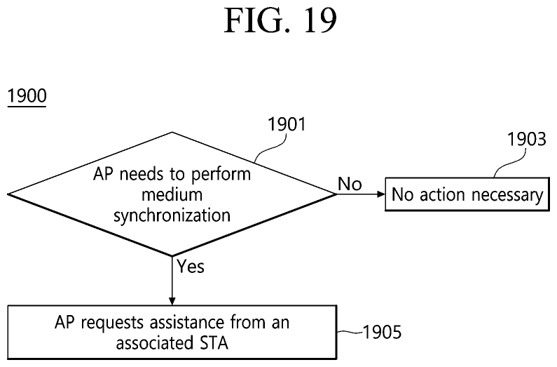

FIG. 19 illustrates an example process for STA assisted medium synchronization recovery in accordance with an embodiment. The process can perform operation 1901 where the AP determines whether it needs to perform medium synchronization. If the AP determines that it does not need to perform medium synchronization, the process performs operation 1903 where no action is necessary. If the AP determines that it does need to perform medium synchronization, the process performs operation 1905 where the AP requests assistance from an associated STA. The STA that the AP requests the assistance from can be an STA that is not in PS mode. For example, STAs that intend to transition to doze state can inform the AP about their intention to transition to doze state. AP can seek assistance only from those STAs that have not informed the AP about their intention to transition to doze state. In some embodiments, if STA is in PS mode, AP can also wake up the STA via a cross link wake up request. In some embodiments, AP can also check the state of the STA via a cross link state check frame and send the request frame for medium synchronization recovery only if the STA is in awake state.

In some embodiments, a cross link assistance request can be transmitted on one of the other links of the AP MLD, where the other link is for an AP that is not the same AP that needs medium synchronization recovery assistance, to one of the other STAs affiliated with the non-AP MLD. In some embodiments, the STA may not be on the same link as the AP that needs assistance. In some embodiments, the assistance can be requested by the same AP that may need the assistance by transmitting the request frame prior to going to PS mode.

In some embodiments, the cross link assistance request frame can include at least one or more of the information items that are indicated in Table 3. The reason code can be different to reflect that this is for assistance request from STA instead of a neighbor AP. The STA can send a response frame if it is in wake state which can include at least one or more of the information items as indicated in Table 4. In some embodiments, the STA can send no response if it cannot comply with the request of the AP and after a timeout period, the AP can send a request to another STA.

In some embodiments, the request and response can be made via an independent frame or other frames in the standard. In some embodiments, a request and response frames can be used with an indication in the reason code that the frame is intended for STA assistance request. In some embodiments, the request can be a control subfield variant of an A-control subfield. In some embodiments, the control subfield can be an application-aware routing (AAR) control subfield. The assisting AP Link ID bitmap can be used for requesting assistance from the STA instead. A value of 1 in bit position i of the assisting AP Link ID bitmap subfield can indicate the STA operating on link ID i is requested to assist with the recovery of medium synchronization of the AP on the link with link ID i. A value of 0 in the bit position i of the assisting AP link ID bitmap subfield can indicate that the STA operating on link ID i is not requested to assist with the recovery of medium synchronization.

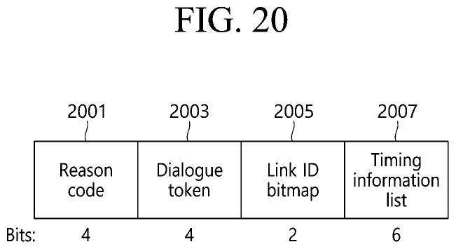

In some embodiments, there can be another control sub-field variant of an A-control subfield. FIG. 20 illustrates a control subfield variant of an A-control subfield in accordance with an embodiment. The A-control subfield can include a Reason code field 2001, Dialogue token field 2003, Link ID bitmap field 2005, and Timing information indication field 2007.

The reason code field 2001 can carry a value that indicates that this A-control subfield is being transmitting for requesting STA's assistance in AP's medium synchronization recovery. The dialogue token 2003 field can carry a unique value that is generated by the AP and can be used as a reference to the AP's request. The link ID bitmap field 2005 can indicate the links on which the assistance is being requested for. A value of 1 in bit position i of the assisting AP Link ID bitmap subfield can indicate the STA operating on link ID i is requested to assist with the recovery of medium synchronization of the AP on the link with link ID i. A value of 0 in the bit position i of the assisting AP link ID bitmap subfield can indicate that the STA operating on link ID i is not requested to assist with the recovery of medium synchronization. The timing information subfield 2007 can be an encoding that indicates the time by which this help may be needed. In some embodiments, there can be a code to indicate that this assistance is needed immediately, a code to indicate that the help is needed at the wake up time that the AP has indicated to the STA in advance. For example, via beacon frames that advertise the sleep schedule of the AP or any other signaling advertising the schedule such as TWT based signaling.

In some embodiments, the response frame can also be a control subfield variant of an A-control subfield with the same format as in FIG. 20. The reason code field 2001 can carry a value that indicates that this A-control subfield is being transmitting for responding to AP's request for STA's assistance in AP's medium synchronization recovery. The dialogue token field 2003 can carry the same value that was indicated by the AP in the AP's request. The link ID bitmap field 2005 can indicate the links on which the assistance can be provided. A value of 1 in bit position i of the assisting AP Link ID bitmap subfield can indicate the STA operating on link ID i can assist with the recovery of medium synchronization of the AP on the link with link ID i. A value of 0 in the bit position i of the assisting AP link ID bitmap subfield can indicate that the STA operating on link ID i cannot assist with the recovery of medium synchronization. The timing information subfield 2007 can be an encoding that indicates the time by which this help can be needed. In some embodiments, there can be a code to indicate that this assistance is needed immediately, another code to indicate that the assistance is needed at the wake up time that the AP has indicated to the STA in advance. For example, via beacon frames that advertise the sleep schedule of the AP or any other signaling advertising the schedule such as TWT based signaling.

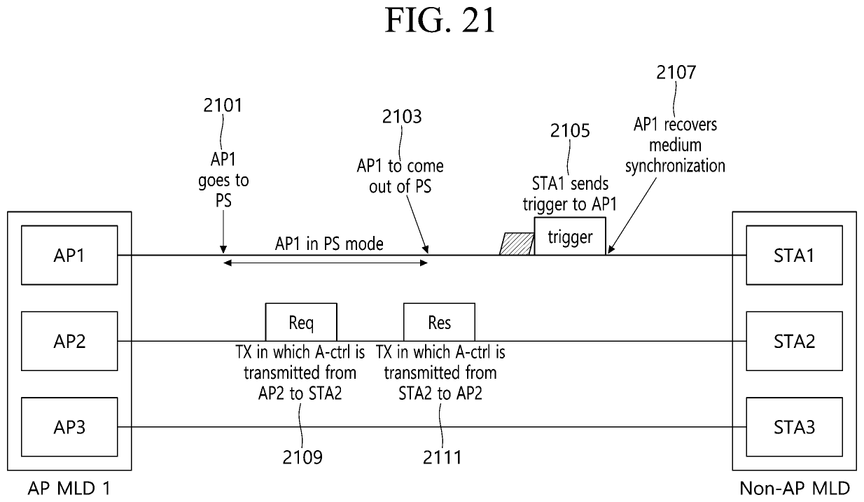

FIG. 21 illustrates A-control subfield usage for medium synchronization recovery assistance from a non-AP MLD in accordance with an embodiment. AP MLD1 includes AP1, AP2, and AP3 and non-AP MLD includes STA1, STA2, and STA3. As AP1 goes into PS mode at an indicated time 2101 and intends to come out of PS mode at another indicated time 2103 as illustrated, AP2 affiliated with AP MLD1 can transmit a frame 2109 that includes an A-control subfield to STA2 affiliated with non-AP MLD. The frame can be, for example, an ongoing transmission or a QoS Null frame. Upon receiving the A-control subfield carrying the request, the non-AP MLD processes the request and generates a response 2111 transmitted as a part of another transmission from STA2 to AP2. Upon indicating the response to provide assistance, STA1 affiliated with non-AP MLD transmits a trigger frame 2105 to AP1. Upon receiving the trigger frame, AP1 recovers medium synchronization 2107.

In some embodiments, if the non-AP MLD also performs PS, it may be possible that at the time when the AP needs the assistance, the non-AP MLD is either in PS or has also lost medium synchronization. When both AP and STA loose medium synchronization, medium synchronization assistance can be requested from a neighboring AP.

In some embodiments, a cross link wake up request can be transmitted to a non-AP MLD to bring one of its affiliated STAs out of doze state. This STA can then assist the AP in medium synchronization recovery. The cross link wake request can include at least one or more of the information items as indicated in Table 3. The reason code can indicate that the reason for sending the request is to wake up one of the affiliated STAs. The cross link wake up request can be an independent frame or any of the existing frames in the standard.

In some embodiments, the format can be the same as shown in FIG. 15. The Reason code field 1507 can indicate the reason for sending the information element. For example, the reason code field can include a value for a code that can indicate that this frame is a cross link wake up request. The link ID bitmap field 1511 can indicate the links for which the STAs need to be woken up. A value of 1 in bit position i of the bitmap can indicate to the non-AP MLD that the affiliated STA on the link with link ID equal to i needs to wake up to provide the support for assisted medium synchronization. A value of 0 in the bit position i of the bitmap can indicate to the requesting non-AP MLD that the affiliated STA on the link with link ID equal to i can continue in its current state (because assistance was not requested). The timing information list field 1513 may be a list of timing information (each 2 octets long) for each of the link(s) for which assistance can be provided in the same order. The receiving non-AP MLD may need to wake up considering this timing information and be ready to provide assistance in time.

In some embodiments, the cross link state check frame can be transmitted by the AP first to check the state of the STA. The cross link state check frame can include one or more of the information items as indicated in Table 5.

TABLE 5
Information items that can be present in the cross link state check frame

| Information | |
|---|---|
| item | Description |
| Reason info | An information item that describes the reason for sending the frame. e.g., a |
| | reason code |
| Reference | An information item that describes a reference for the frame. e.g., a dialogue |
| info | token |
| State check | An information item that indicates the link on which the state needs to be |
| info | checked. e.g., a bitmap |

The above information can be carried in an independent frame or in any of the frames existing in the standard (e.g., an action frame, among others).

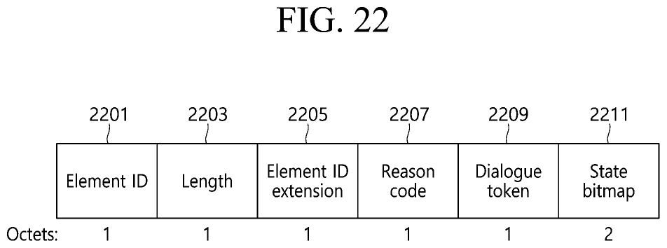

FIG. 22 illustrates a state check frame format in accordance with an embodiment. The state check frame format can include an Element ID field 2201, Length field 2203, Element ID extension field 2205, Reason code field 2207, Dialogue token field 2209, and State bitmap field 2211.

The element ID field 2201 can provide an identifier for the element. The length field 2203 can provide a length of the information element. The element ID extension field 2205 can provide an element ID extension field for the information element.

The reason code field 2207 can indicate the reason for sending the information element (e.g., a value for a code that can indicate that this frame is making a request for medium synchronization assistance). The dialogue token field 2209 can be a unique integer value generated by the requesting AP and can be used as a reference for this request.

The state bitmap field 2211 can indicate the STAs for which the state is being requested. A value of 1 in bit position i of the bitmap can indicate to the non-AP MLD that the state of the affiliated STA on the link with link ID equal to i is being requested. A value of 0 in the bit position i of the bitmap can indicate to the requesting non-AP MLD that the state of the affiliated STA on the link with link ID equal to i is not being requested. In some embodiments, the state bitmap field 2211 field can be optional and the reason code field 2207 can indicate that the state of all affiliated STAs need to be provided.

In some embodiments, a response frame can have a similar format to FIG. 22. The state bitmap field 2211 can indicate the STAs that are in wake state. A value of 1 in bit position i of the bitmap can indicate to the AP MLD that the state of the STA affiliated with the non-AP MLD on the link with link ID equal to i is wake state. A value of 0 in the bit position i of the bitmap can indicate to the requesting AP MLD that the state of the STA affiliated with the non-AP MLD on the link with link ID equal to i is not wake state. After checking the state of the STAs, AP MLD can request assistance from the STAs that are in wake state using the techniques described herein.

In some embodiments, upon receiving a request frame, the non-AP MLD can send a trigger frame to the AP on the indicate links to help the AP with medium synchronization recovery. Once the AP receives this trigger frame, it can recover medium synchronization.

In some embodiments, once the AP performs medium synchronization recovery, it can transmit a frame to the associated STAs to inform them that the AP has recovered medium synchronization. This frame can be any of the frames existing in the standard (e.g., a beacon frame, among others). AP can also start transmitting DL data to STAs associated with it or trigger STAs that are in wake state to transmit PPDU on the uplink. Such frame transmissions can also implicitly indicate that the AP has recovered medium synchronization.

In some embodiments, an AP that can request for medium synchronization assistance can advertise this in one or more frames that it transmits (e.g., beacon frames, among others). Devices that hear the beacon frame can discover that the AP performs power save and can make such a request.

In some embodiments, the beacon frame can carry a field that can carry a bit (e.g., medium sync assistance requester) which can be used to make an indication for medium synchronization assistance. When this bit is set to 1, the AP can request for medium synchronization and when 0 it cannot make a request.

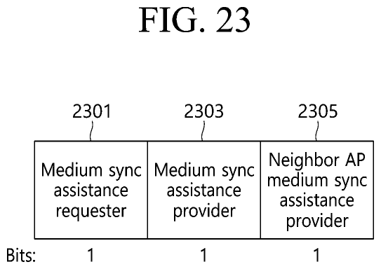

FIG. 23 illustrates a beacon frame format to advertise capability support in accordance with an embodiment. The beacon frame format can include a Medium sync assistance requester field 2301, Medium sync assistance provider field 2203, and Neighbor AP medium sync assistance provider field 2305.

The format can include a medium sync assistance requester field 230 that can be set to 1 to indicate that the assistance can be requested and 0 to indicate that the assistance cannot be requested.

The medium syn assistance provider field 2303 can be set to 1 to indicate that the assistance can be provided and 0 to indicate that the assistance cannot be provided.

The neighbor AP medium sync assistance provider field 2305 can be set to 1 to indicate that the assistance can be provided by a neighbor AP and 0 to indicate that the assistance cannot be provided by the neighbor AP.

An AP MLD that can provide support to its neighbors in AP assisted medium synchronization procedure can advertise the capability in one or more frames that it transmits. APs that hear such an advertisement can understand that it can request assistance from this AP in the future. In some embodiments, the beacon frame can carry a field with a bit (neighbor AP medium sync assistance provider 2305) which can be set to 1 to indicate that the assistance can be provided and 0 to indicate that the assistance cannot be provided.

In some embodiments, a non-AP MLD that can provide support to its AP MLD in STA assisted medium synchronization procedure can advertise the capability in one or more frames that it transmits. The frames can include probe/association request frames, among others. AP MLDs that receive such an indication from the non-AP MLD can understand that the non-AP MLD can provide this assistance and can make requests from the non-AP MLD for assistance. In some embodiments, a same field can be included in probe/association requests with a bit to make this indication (e.g., medium sync assistance provider 2303). The bit can be set to 1 by non-AP MLDs that can provide the assistance and to 0 by non-AP MLDs that do not provide such an assistance. The receiving AP MLDs can then determine whether the non-AP MLD can provide the support and make requests from the non-AP MLDs that are able to provide support.

Some embodiments can include link management for power save. In some embodiments, the one or more links created by an AP MLD can be divided into two categories—(1) power save (PS) link and (2) non-power save (non-PS) link or active link. AP MLD may perform PS only on power save links whereas the AP MLD can refrain from performing PS on non-power save links. In some embodiments, the non-PS link can be fixed for a BSS. In some embodiments, the non-PS links can be changed and converted to PS links and vice versa.

In some embodiments, an AP on the PS link can perform PS operation for energy savings. The AP can consider a number of conditions to decide whether or not to perform PS on a link. The conditions can include but not be limited to the following conditions. In some embodiments, the AP can consider whether the STA that operates on the PS link is affiliated with a non-AP MLD that supports procedures for handling AP-side PS. The AP may consider whether the STA(s) is not a legacy STA in determining whether to perform PS on a link. The AP may consider that the latency constraints of latency sensitive traffic are not violated when performing PS on the PS link. If the latency constraints of latency sensitive traffic cannot be met on the PS link, then that traffic can be mapped to non-PS links instead. Accordingly, in some embodiments, there can be a general understanding/procedure to change the mapping when the AP on the PS link goes to doze state and remapping when it comes out of doze state and the AP can perform PS only if all the STAs on that link have such an understanding/procedure support.

In some embodiments, the non-PS links can be used for certain types of traffic, including the following. A non-PS link can help with transmission of mandatory/necessary management frames. For example, a non-PS link can be used for transmission of beacon frames. As PS links can go to the doze state, they may not be able to send beacon frames during the doze period. Beacon frames transmitted on non-PS links can carry certain necessary and/or relevant information (e.g., TIM element, EDCA parameter set element, MU EDCA parameter set element, among others) for the PS links when required.

In some embodiments, a non-PS link can handle traffic of non-AP MLDs that do not support procedures for handling AP-side PS mode. Such non-AP MLDs can communicate with the AP MLD on non-PS link.

In some embodiments, a non-PS link can handle latency sensitive traffic as such traffic can face delays on the PS link as the AP goes to doze state.

In some embodiments, a non-PS link can handle multi-AP coordination related frame exchanges with neighboring AP MLDs. As PS link can go to doze state, some of the frames transmitted by the neighboring AP MLD can be missed on this link by the AP MLD that those frames are intended for if the corresponding AP on that link goes to or is in the doze state during the transmission of such frames.

A non-PS link can facilitate discovery and association with the AP MLD. As the AP on the PS link goes to the doze state, it may not be available for responding to probe requests, (re) association requests, among others. A non-PS link can facilitate disassociation with the AP MLD. As the AP on the PS link goes to the doze state, it may not be available for receiving the disassociation frame. A non-PS link may facilitate a setup, modification, teardown among various other procedures described herein when the PS link goes to doze state. A non-PS link can facilitate exchanges of cross link wake up request frames.

In some embodiments, the AP can consider a number of conditions to decide which link to make non-PS link, including the following. In some embodiments, the AP may consider whether the primary channel of the non-PS link is the same as the primary channel of the neighboring AP's non-PS link for MAP coordination related frame exchanges. The AP may consider whether the primary channel of the non-PS link is a part of the operational bandwidth of the neighboring AP's non-PS link for MAP coordinated related frame exchanges. The AP may consider whether the link may handle latency sensitive traffic without any performance degradation. The AP may consider various coordination requirements with non-managed networks (e.g., P2P, Mobile AP, among others) and whether the requirements can be handled on the link. For example, if there is a mobile AP that is connected to the AP MLD, then it can use the non-PS link(s) for backhaul related purposes.

In some embodiments, the AP may consider whether emergency traffic can be mapped to the non-PS links when necessary. For example, if the AP MLD has a Emergency Preparedness Communications Service (EPCS) non-AP MLD associated with it, then it can provide Enhanced Distributed Channel Access (EDCA) parameter set and MU EDCA parameter set to the non-AP MLD on the non-PS links that result in higher priority for the STA affiliated with the non-AP MLD on the non-PS link(s).

Some embodiments can include an announcement procedure for non-PS and PS links. In some embodiments, the AP MLD can announce which of the links created by it are non-PS links and which links are PS links. In some embodiments, the AP MLD can announce the non-PS and/or PS links in one or more frames that it transmits. These frames can include at least one or more of the information items as indicated in Table 6.

TABLE 6
Information items that can be present in the announcement

| Information item | Description |
|---|---|
| Non-PS link | An information item that can describe the link(s) that can act as non-PS |
| information | link(s). e.g., Link ID, Link ID bitmap, among others. |
| Non-PS link | An information item that can describe the duration for which the link(s) |
| duration | indicated above can act as non-PS link. e.g., a list of durations in TBTT, |
| information | TU, among others. This can also be the periodicity related information |
| | in case there is an ON-OFF duty cycling of PS and non-PS link(s). |
| Configuration | An information item that indicates if the configuration is static or can |
| information | be changed by the AP/STA based on notification and/or negotiation. |
| | e.g., a field that can take a pre-known/pre-determined value to indicate |
| | if the configuration is static or not. |
| PS link information | An information item that can describe the link(s) that can act as PS |
| | link(s). e.g., Link ID, Link ID bitmap, among others. |
| PS link duration | An information item that can describe the duration for which the link(s) |
| | indicated above can act as PS link. e.g., a list of durations in TBTT, TU, |
| | among others. |
| Change procedure | An information item that can indicate the procedure to change the |
| | PS/non-PS link(s) configuration. e.g., a field that can take a pre- |
| | known/pre-determined value to indicate if the configuration can be |
| | changed based by AP-side, by STA negotiation, by both AP and STA |
| | negotiation, among others. |
| Change time | An information item that can indicate the time at which the AP can |
| | change the PS and non-PS link(s) configuration. e.g., this can be a |
| | timing information that the AP can include if the PS and non-PS link(s) |
| | configuration information that it is indicating in the current |
| | announcement frame is the new configuration that can take effect at the |
| | indicated time. |

The information items can be present in the same frame or in different frames. The information items can be carried in a newly defined frame or in any of the frames existing in the standard (e.g., management frames, among others).

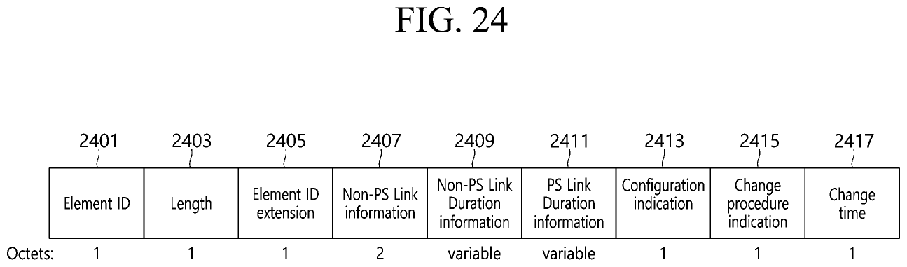

FIG. 24 illustrates an information element that can include announcement information in accordance with an embodiment. The information element can include Element ID field 2401, Length field 2403, Element ID extension field 2405, Non-PS link information field 2407, Non-PS link Duration information field 2409, PS Link Duration information field 2411, Configuration indication field 2413, Change procedure indication field 2415, and Change time field 2417.

The element ID field 2401 can provide an identifier for the element. The length field 2403 can provide a length of the information element. The element ID extension field 2405 can provide an element ID extension field for the information element.

The non-PS link information field 2407 can be a bitmap which can indicate which links can be non-PS links. A value of 1 in bit position i of the bitmap can indicate that the AP affiliated with the AP MLD operating on the link with link ID equal to i can stay in active mode and not perform power save, which are the non-PS link(s). A value of 0 in bit position i of the bitmap can indicate to the non-AP MLD that the AP affiliated with the AP MLD operating on the link with link ID equal to i can perform power save, which are the PS link(s).

The non-PS link duration information field 2409 can be a list of durations in TBTT for which the links indicated in the non-PS link information field can stay as non-PS links. The durations can be arranged in the same order as the bit indication order for non-PS links in the non-PS link information field. For example, if there is a value of 1 in bit position i, i+1 and i+2 of the non-PS link information field bitmap and the remaining bits position have a value of 0, then the non-PS link duration can be a list of 3 duration values the first of which can corresponding to the link with link ID equal to i, the second value can correspond to the link with link ID equal to i+1, and the third value can correspond to the link with link ID equal to i+2.

The PS link duration information field 2411 can be a list of durations in TBTT for which the links indicated in the non-PS link information field (with a value of 0 in the bit location) can stay as PS links. The durations can be arranged in the same order as the bit indication order for PS links in the PS link information field. For example, if there is a value of 0 in bit position i, i+1 and i+2 of the non-PS link information field bitmap and the remaining bits position have a value of 1, then the PS link duration can be a list of 3 duration values the first of which can corresponding to the link with link ID equal to i, the second value can correspond to the link with link ID equal to i+1, and the third value can correspond to the link with link ID equal to i+2.

The configuration indication field 2413 can take a value of 1 when the PS links and the non-PS links are re-configurable. In particular, the AP can change which links are PS links and which links are non-PS links over time or based on a certain condition. This indication can be useful to the non-AP MLD in cases where the non-PS links are being used for handling latency sensitive traffic but are not suitable for its operation (e.g., due to congestion, RF degradation, among others), it can request the AP for a reconfiguration of PS and non-PS links. When the indication field is set to 0, the PS links and the non-PS links can be fixed for the lifetime of the BSS. In some embodiments, if the non-PS links are not suited for the non-AP MLD, it can associate with another AP MLD if a suitable one is available. The remaining 7 bits of this field can remain reserved.

In some embodiments, if the PS and the non-PS links are reconfigurable, then the change configuration can take values based on what kind of reconfiguration procedure the AP can support. In some embodiments, the change configuration field can take a value of 1 to indicate that the links can be reconfigured only by the AP MLD, it can take a value of 2 to indicate that the AP MLD is open to negotiation of the links based on preference indication by the non-AP MLD, among others. The AP MLD can chose a value based on its design or based on certain conditions. For example, if the AP MLD has a few number of non-AP MLDs associated with it, it can indicate that it is open to negotiation based on the preference indication of the non-AP MLD. However, if the AP MLD has a large number of non-AP MLDs associated with it, then such preference indication can potentially result in large overhead and the AP can stop making such an indication.

The change time field 2417 can indicate the time until the next TBTT at which point the newly indicated configuration can take effect. If a new configuration is not being announced by the AP MLD, then this field can be reserved. The information element can be carried in any independent frame (e.g., a newly defined action frame) or any of the existing frames (e.g., management frames such as beacon frames, probe response frames, among others).

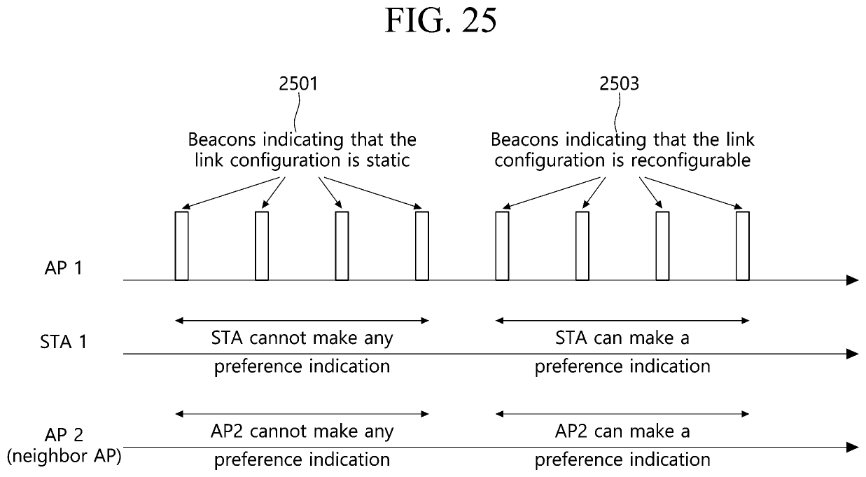

FIG. 25 illustrates transmission of an information element in beacon frames in accordance with an embodiment. AP1 (affiliated with an AP MLD not shown in the figure for the sake of simplicity) can transmit a beacon frame that includes the information element. Devices that hear the beacon frame (such as associated STA, neighbor APs, among others) can understand based on the information element if they can make a preference indication or not. As illustrated, AP1 transmits beacon frames 2501 indicating that the link configuration is static, as such STA 1 and AP2 cannot make any preference indication. At a second time, AP1 transmits beacon frames 2503 indicating that the link configuration is reconfigurable, during which STA1 and AP2 can make a preference indication.

Some embodiments can include multi-link setup based on PS constraint. In some embodiments, an AP MLD can stop advertising or providing information related to or prevent association/operation on PS links for one or more non-AP MLDs. For example, when dealing with a non-AP MLD that does not support procedures necessary to support AP PS mode (e.g., legacy non-AP MLDs). In some embodiments, the AP MLD can force such non-AP MLDs to form links only on non-PS links and prevent them from operating on PS links.

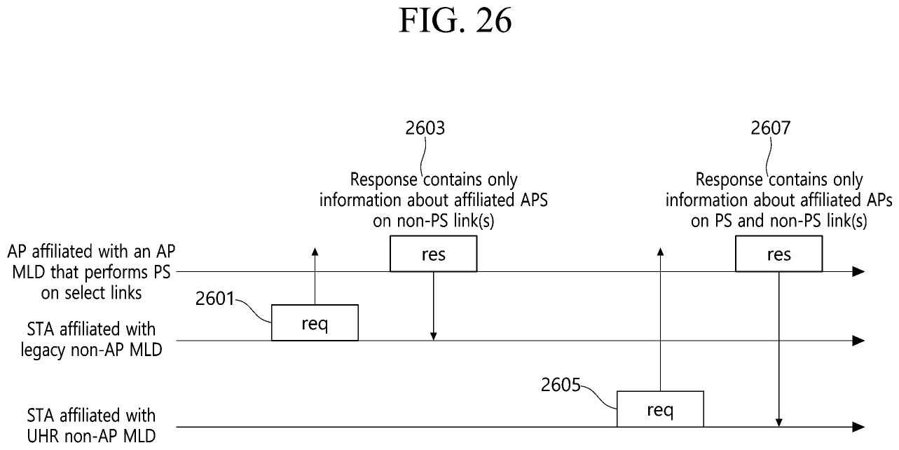

FIG. 26 illustrates an exchange of information about affiliated APs on PS and non-PS links in accordance with an embodiment. As illustrated in FIG. 26, an STA affiliated with a non-AP MLD that does not support operation on PS links (e.g., legacy non-AP MLD) may transmit a request frame 2601 to an AP affiliated with an AP MLD. The STA may request information about the other APs affiliated with the same AP MLD. The AP of the AP MLD can then transmit information 2603 only for the APs that operate on the non-PS links.

In some embodiments, an STA affiliated with a non-AP MLD that supports operation on PS links (e.g., ultra high reliability (UHR) non-AP MLD) may transmit a request frame 2605 to the AP affiliated with an AP MLD to request information about other APs affiliated with the same AP MLD. Accordingly, the AP of the AP MLD can transmit information 2607 for APs that operate on PS links as well as those that operate on non-PS links.

In some embodiments, a request frame can be a request frame from various different types of request frames used in IEEE 802.11 operation (e.g., probe request frame, authentication request frame, association request frame, among others).

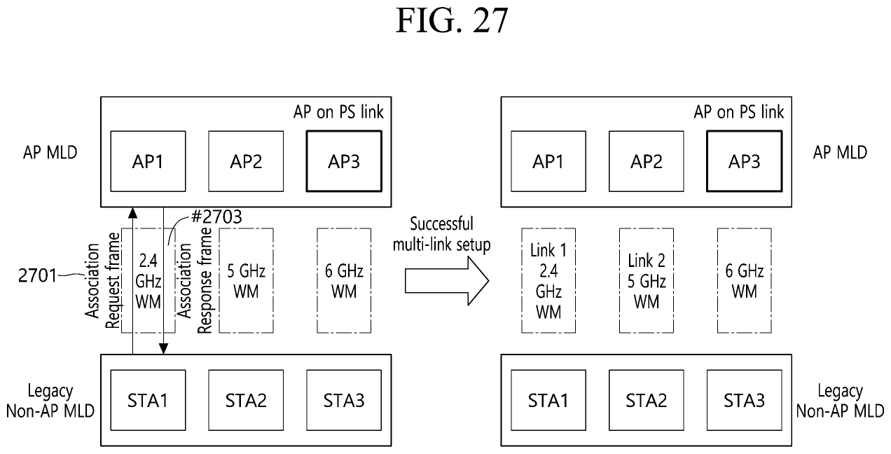

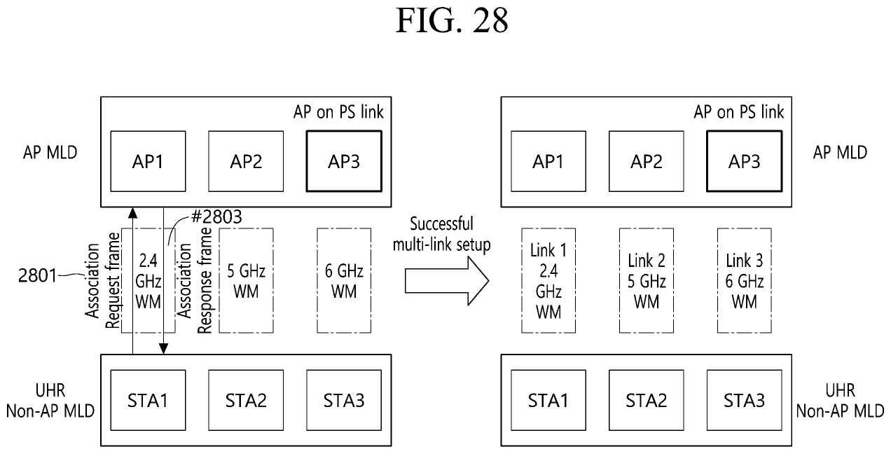

FIG. 27 and FIG. 28 illustrate an example related to association request frame and response during multi-link setup in accordance with an embodiment. In particular, FIG. 27 illustrates a multi-link setup for AP MLD with PS links in accordance with an embodiment. The AP MLD may have three affiliated APs—AP1 that operates on the 2.4 GHz band, AP2 that operates on 5 GHz band and AP3 that operates on 6 GHz band.

In FIG. 27, non-AP MLD is a legacy non-AP MLD that has three affiliated STAs, STA1, STA2, and STA3. Non-AP MLD can initiate multi-link setup procedure during which STA1 affiliated with non-AP MLD can transmit an association request frame 2701 to AP1 affiliated with AP MLD. The association request can include a basic multi-link element that includes a complete profile of STA1 in the frame body of the association request frame and STA2 and STA3 in the per-STA profile sub-element carried in the basic multi-link element to request for link setup between the AP MLD and the non-AP MLD. When the AP MLD responds to the multi-link setup, AP1 affiliated with AP MLD can transmit an association response frame 2703 to STA1 to indicate successful multi-link setup. In the association response frame, the basic multi-link element can include a complete profile of AP1 (in the frame body of the association request frame) and AP2 (in the per-STA profile sub-element carried in the basic multi-link element). AP3's information can be skipped to avoid the non-AP MLD from forming a link with AP3.

FIG. 28 illustrates multi-link setup for AP MLD with non-PS links in accordance with an embodiment. In FIG. 28, non-AP MLD is a non-AP MLD that supports power save and has three affiliated STAs, STA1, STA2, and STA3. Non-AP MLD can initiate multi-link setup procedure during which STA1 affiliated with non-AP MLD can transmit an association request frame 2801 to AP1 affiliated with AP MLD. The association request can include a basic multi-link element that includes a complete profile of STA1 in the frame body of the association request frame and STA2 and STA3 in the per-STA profile sub-element carried in the basic multi-link element to request for link setup between the AP MLD and the non-AP MLD. When the AP MLD responds to the multi-link setup, AP1 affiliated with AP MLD can transmit an association response frame 2803 to STA1 to indicate successful multi-link setup. In the association response frame, the basic multi-link element can include a complete profile of AP1 (in the frame body of the association request frame) and AP2 as well as AP3 on PS link (both in the per-STA profile sub-element carried in the basic multi-link element).

In some embodiments, the PS and non-PS links can be negotiated. In some embodiments, there can be a requesting entity (e.g., a non-AP MLD, neighboring AP MLD, P2P device, Mobile AP MLD, etc.) which can transmit a negotiation request to the AP MLD to negotiate the non-PS links. There can be a number of reasons for such a negotiation. For example, a non-AP MLD can find that the current PS links are not suitable for operation of its low latency or latency sensitive traffic and can request the AP MLD to change the PS links.

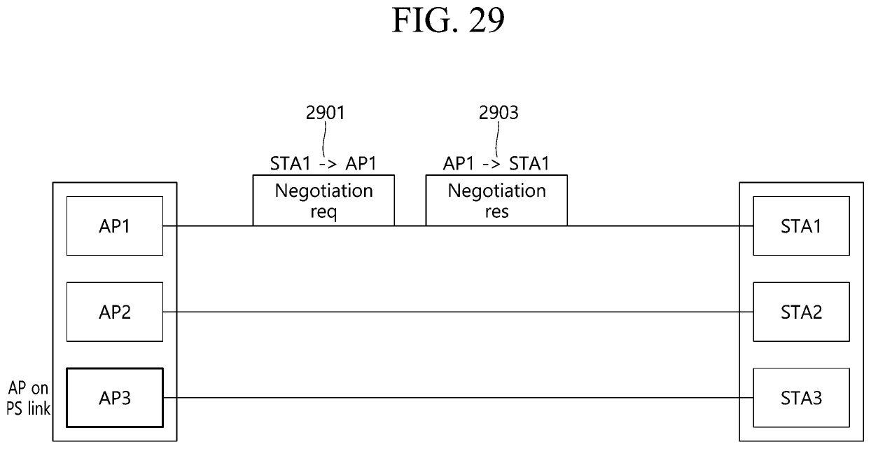

FIG. 29 illustrates negotiation for non-PS and PS links in accordance with an embodiment. In FIG. 29, non-AP MLD can transmit a negotiation request frame 2901 to the AP MLD via at least one or more of its affiliated STAs, STA1, STA2 or STA3. In particular STA1 transmits the negotiation request frame 2901 to AP1. The AP MLD can transmit a response frame 2903 to the non-AP MLD upon receiving such a frame. In particular, AP1 transmits the response frame 2903 to STA1. The negotiation request frame can include at least one or more of the information items as indicated in Table 7.

TABLE 7
Negotiation request frame information content

| Information item | Description |
|---|---|
| Reason information | An information item that indicates the reason for sending the |
| | negotiation request. For example, this can be done via a reason code. |
| Token information | An information item that serves as a reference for the negotiation |
| | request frame. e.g., a dialogue token. |
| New configuration | An information item that indicates the new desired non-PS link(s) |
| | configuration. e.g., a link ID bitmap. This can also be an information |
| | item that indicates the new desired PS link(s). |
| Problematic link | An information item that can indicate which of the current non-PS/PS |
| indication | link(s) the STA has an issue with. e.g., a link ID bitmap. |
| Desired switch | An information item that can indicate the time at which the new |
| duration | proposed configuration is desired to take effect. e.g., timing |
| | information in terms of TBTT, TU, among others. |

The negotiation response frame can include at least one or more of the information items as indicated in Table 8.

TABLE 8
Negotiation response frame information content

| Information item | Description |
|---|---|
| Reason information | An information item that indicates the reason for sending the |
| | negotiation response. In one example, this can be done via a reason |
| | code. |
| Token information | An information item that serves as a reference for the negotiation |
| | request frame. e.g., the same dialogue token that was mentioned in the |
| | negotiation request frame. |
| Status information | An information item that indicates the status of the request. e.g., a |
| | status code indicating success, failure, delayed, among others. |
| New configuration | An information item that indicates the new non-PS link(s) |
| | configuration as determined by the AP MLD. e.g., a link ID bitmap., |
| | This can also be an information item that indicates the new PS link(s) |
| | as determined by the AP MLD. |
| Desired switch | An information item that can indicate the time at which the new |
| duration | proposed configuration can take effect. e.g., timing information in |
| | terms of TBTT, TU, among others. |

The information items indicated in Table 7 and 8 can be included in one or more frames exchanged between the requesting entity and the AP MLD. The information items can be carried in newly defined frames or in any of the existing frames in the standard.

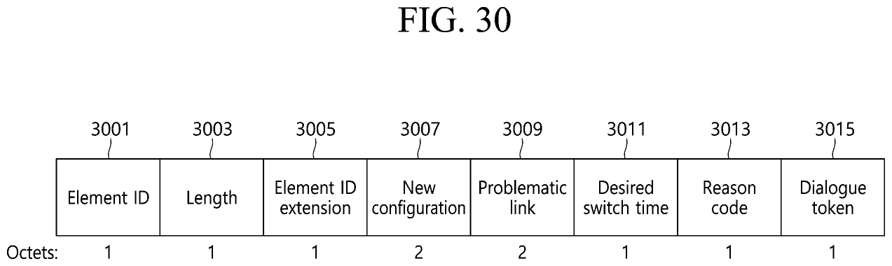

FIG. 30 illustrates negotiation request frame format in accordance with an embodiment. The negotiation request frame can include Element ID field 3001, Length field 3003, Element ID extension field 3005, New configuration field 3007, Problematic link field 3009, Desired switch time field 3011, Reason code field 3013, Dialogue token field 3015.

The element ID field 3001 can provide an identifier for the element. The length field 3003 can provide a length of the element. The element ID extension field 3005 can provide an element ID extension field for the element.

The new configuration field 3007 can be a bitmap to indicate the new configuration that the non-AP MLD is proposing for non-PS links (or alternatively PS links). A value of 1 in bit position i of the bitmap can indicate that the non-AP MLD is proposing that the AP affiliated with the AP MLD operating on the link with link ID equal to i can run PS operation mode, i.e., the link becomes a PS link. A value of 0 in bit position i of the bitmap can indicate to the AP MLD that the non-AP MLD proposes that the AP affiliated with the AP MLD operating on the link with link ID equal to i can turn off PS operation mode, i.e., the link becomes a non-PS link.

The problematic link field 3009 can be a bitmap to indicate the current link that are problematic for the non-AP MLD. A value of 1 in bit position i of the bitmap can indicate that the non-AP MLD has a problem with the non-PS link with link ID equal to i and a different link is needed as a substitute. A value of 0 in bit position i of the bitmap can indicate to the AP MLD that the non-AP MLD does not have a problem with the link with link ID equal to i and that link can continue to operate in its current PS mode configuration.

The desired time field 3011 can be time until the next TBTT when the non-AP MLD requests the new configuration to take effect.

The reason code field 3013 can indicate the reason for sending the frame. For example, a pre-known value that can indicate that the reason for sending this frame is because the non-AP MLD faces congestion on the current non-PS link.

The dialogue token field 3015 can be a unique value that can be generated by the requestor.

The requestor can also be a neighbor AP MLD instead of a non-AP MLD. In such a case, the purpose of sending this frame can be to have PS links which can be used for multi-AP coordination. For example, if the neighbor AP MLD feels that a particular link is preferred or better for exchange of multi-AP coordination related information/signaling and if that link is currently a PS link, then the neighbor AP MLD can transmit a negotiation request frame to make that link a non-PS link.

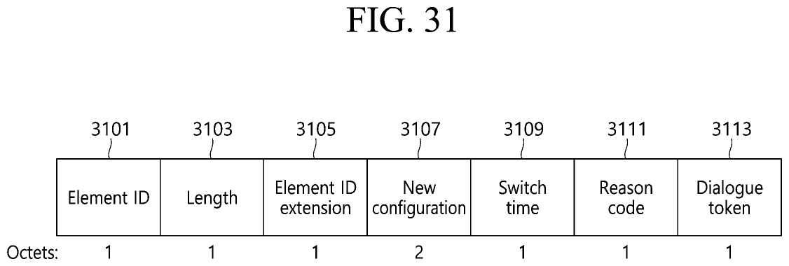

FIG. 31 illustrates a negotiation response format in accordance with an embodiment. The negotiation response format can include Element ID field 3101, Length field 3103, Element ID extension field 3105, New configuration field 3107, Switch time field 3109, Reason code field 3111, and Dialogue token field 3113.

The element ID field 3101 can provide an identifier for the element. The length field 3103 can provide a length of the element. The element ID extension field 3105 can provide an element ID extension field for the element.

The new configuration field 3107 can be a bitmap to indicate the new configuration that the AP MLD is proposing for non-PS links (or alternatively PS links). A value of 1 in bit position i of the bitmap can indicate that the AP MLD is proposing that the AP affiliated with the AP MLD operating on the link with link ID equal to i can run PS operation mode i.e., the link becomes a PS link. A value of 0 in bit position i of the bitmap can indicate that the AP MLD proposes that the AP affiliated with the AP MLD operating on the link with link ID equal to i can turn off PS operation mode i.e., the link becomes a non-PS link.

The switch time field 3109 can the time until the next TBTT when the AP MLD can make the new configuration come into effect.

The reason code field 3111 can indicate the reason for sending the frame. For example, a pre-known value that can indicate the reason for sending this frame is in response to the requestor's negotiation frame. The negotiation response frame can be transmitted in response or in an unsolicited manner as well (e.g., if the AP MLD determines the change on its own and transmits the frame to inform its associated non-AP MLDs, neighbor AP MLDs, among others).

The dialogue token field 3113 can be the same value in the negotiation request. In case when the response frame is transmitted in an unsolicited manner, this field can be reserved. In both the above frames, one or more fields can be optional.

The negotiation request and response frames can be carried in newly defined frames (e.g., newly defined action frames) or in existing frames in the standard (e.g., beacon frames when exchanged between AP MLDs).

When an AP MLD performs a PS and non-PS links configuration change, it can perform an AP removal and AP adding procedure for the non-AP MLDs that operate only on the non-PS links due to lack of support for AP-side PS procedures in order to move such non-AP MLDs to new non-PS links. When doing so, the AP MLD can indicate to the non-AP MLDs that operate on PS links that the AP removal or AP adding procedure is not intended for them and that they can ignore such an indication.

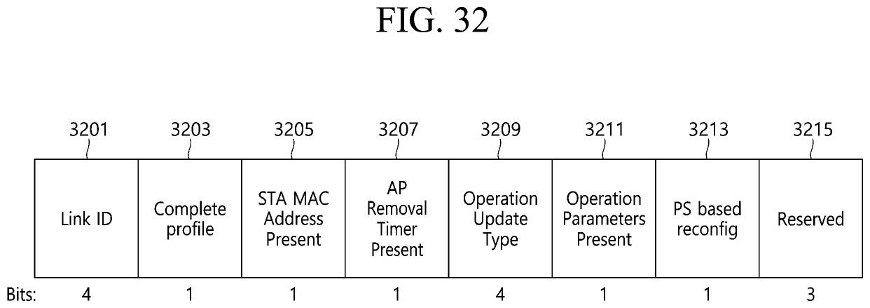

FIG. 32 illustrates a modified STA control field of a reconfiguration multi-link element in accordance with an embodiment. The modified STA control field of the reconfiguration multi-link element can include a Link ID field 3201, Complete profile field 3203, STA MAC Address present field 3205, AP Removal Timer Present field 3207, Operation Update Type field 3209, Operation Parameters Present field 3211, PS based reconfig field 3213, and Reserved field 3215.

The link ID field 3201 can include an identifier for the link. The complete profile field 3203 can include profile information of the element. The STA MAC address present field 3205 can provide information on the STA MAC address. The AP removal timer present field 3207 can provide information on whether the AP removal timer is present. The operation update type field 3209 can provide information on the operation update type. The operation parameters present field 3211 can provide information on whether the operation parameters are present.

The PS based reconfig bit field 3213 can be set to 1 to indicate to the non-AP MLDs that support AP-side PS procedures that this Reconfiguration Multi-link element can be ignored by them and that they can continue to operate on the same set of links. Upon receiving such a reconfiguration multi-link element from the AP MLD, the non-AP MLDs that can ignore it can look at the new PS and non-PS links configuration announced by the AP (e.g., by using the announcement procedures described herein) and operate with the new configuration accordingly. The reserved field 3215 can be a reserved.

When the AP MLD that performs PS is a Mobile AP MLD, it can keep its primary link as one of the non-PS links to enable non-AP MLDs to receive necessary management frames (e.g., beacon frames, probe response, among others).

In some embodiments, when an AP MLD supports PS and non-PS links and/or the procedures described herein, it can make an indication to the non-AP MLD in one or more frames that it transmits to the non-AP MLD. These frames can be newly defined frames or any of the frames existing in the IEEE 802.11 standard (e.g., beacon frames, probe response frames, among others).

When a non-AP MLD supports the capability to understand/respond to the AP MLD's procedures, it can indicate that to the AP MLD in one or more frames that it transmits. These frames can be newly defined frames or any of the frames existing in the IEEE 802.11 standard (e.g., probe request frames, association request frames, among others).

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) device associated with a non-AP device in a wireless network, the AP device comprising:
at least one AP affiliated with the AP device;
a processor coupled to the at least one AP, the processor configured to:
establish one or more links between the AP device and the non-AP device, wherein at least one link is a power save (PS) link that switches between a light PS mode and a non-PS mode;
generate a frame indicating the at least one link; and
transmit the frame to the non-AP device.

2. The AP device of claim 1, where the AP device comprises at least two APs affiliated with the AP device, wherein the processor is configured to:
establish at least two links between the AP device and the non-AP device; and
wherein the frame indicates that each link operates as a power save (PS) link or a non-PS link.

3. The AP device of claim 2, wherein a first AP that has established a first link operating as the non-PS link is in awake state, and a second AP that has established a second link operating as the PS link alternates between the light PS mode and the non-PS mode, the first link being established between the first AP and a first station (STA) affiliated with the non-AP device, the second link being established between the second AP and a second STA affiliated with the non-AP device.

4. The AP device of claim 3, wherein the processor is further configured to cause the first AP to transmit information for the second STA to the first STA via the first link when the second AP is in doze state in the second link.

5. The AP device of claim 3, wherein the processor is further configured to cause the first AP to communicate latency sensitive traffic for the second STA with the first STA via the first link when the second AP is in doze state in the second link.

6. The AP device of claim 2, wherein the processor is further configured to:
receive a request frame, from the non-AP device, requesting reconfiguration for non-PS link and PS link on at least one link between the AP device and the non-AP device; and
in response to the request frame, transmit a response frame, to the non-AP device, indicating reconfiguration for non-PS link and PS link on the at least one link between the AP device and the non-AP device.

7. The AP device of claim 2, wherein a primary channel of a link operating as non-PS link is the same as a primary channel of a link operating as non-PS link in a neighboring AP device.

8. The AP device of claim 2, wherein a primary channel of a link operating as non-PS link is a part of the operational bandwidth of a link operating as non-PS link in a neighboring AP device.

9. The AP device of claim 2, wherein latency sensitive traffic or emergency preparedness communications service (EPCS) traffic is communicated on a link operating as non-PS link.

10. The AP device of claim 2, wherein latency sensitive traffic is communicated on a link operating as a PS link when latency requirements of the latency sensitive traffic are met on the PS link.

11. The AP device of claim 2, wherein multi-AP coordination traffic is communicated on a link operating as non-PS link.

12. A non-access point (non-AP) device associated with an AP device in a wireless network, the non-AP device comprising:
at least one station (STA) affiliated with the non-AP device;
a processor coupled to the at least one STA, the processor configured to:
establish one or more links between the non-AP device and the AP device, wherein at least one link is a power save (PS) link that switches between a light PS mode and a non-PS mode;
receive a frame indicating the at least one link;
cause the at least one STA to communicate with the AP via the at least one link.

13. The non-AP device of claim 12, wherein the non-AP device comprises at least two STAs affiliated with the non-AP device, wherein the processor is configured to:
establish a first link between a first STA affiliated with the non-AP device and a first AP affiliated with the AP device, and a second link between a second STA affiliated with the non-AP device and a second AP affiliated with the AP device;
wherein the frame indicates that the first link operates as non-power save (PS) link and the second link operates as PS link;
wherein the processor is further configured to:
cause the first STA to communicate with the first AP via the first link operating as non-PS link; and
cause the second STA to communicate with the second AP via the second link operating as PS link.

14. The non-AP device of claim 13, wherein the non-PS link is in awake state and the PS link alternates between the light PS mode and the non-PS mode.

15. The non-AP device of claim 13, wherein the second AP is in doze state, wherein the processor is further configured to:
cause the first STA to transmit a trigger frame to the first AP on the first link to wake up the second AP;
receive a frame from the second AP that indicates that the second AP is in awake state; and
cause the second STA to communicate with the second AP on the second link.

16. The non-AP device of claim 13, wherein the processor is further configured to:
receive, from the first AP, latency sensitive traffic for the second STA at the first STA via the first link when the second STA is in doze state in the second link; and
transition the second STA from doze state to awake state.

17. The non-AP device of claim 13, wherein the processor is further configured to:
transmit a request frame to the AP device requesting reconfiguration for non-PS link and PS link on at least one link between the non-AP device and the AP device; and
receive a response frame from the AP device indicating reconfiguration for non-PS link and PS link on the at least one link between the non-AP device and the AP device.

18. The non-AP device of claim 13, wherein a primary channel of a link operating as non-PS link is the same as a primary channel of a link operating as non-PS link in a neighboring AP device.

19. The non-AP device of claim 13, wherein a primary channel of a link operating as a non-PS link is a part of the operational bandwidth of a link operating as non-PS link in a neighboring AP device.

20. The non-AP device of claim 13, wherein latency sensitive traffic or emergency preparedness communications service (EPCS) traffic is communicated on a link operating as non-PS link.
